(19) United States
(12) Patent Application Publication
(10) Pub. No.: US 2026/0235854 A1
(43) Pub. Date: Aug. 13, 2026

(54) OPTICAL IMAGING SYSTEM

(71) Applicant: Samsung Electro-Mechanics Co., Ltd., Suwon-si (KR)

(72) Inventors: Woo Young KIM, Suwon-si (KR); Tae Yeon LIM, Suwon-si (KR); Seong Il CHO, Suwon-si (KR); Jae Hyuk HUH, Suwon-si (KR)

(73) Assignee: Samsung Electro-Mechanics Co., Ltd., Suwon-si (KR)

(21) Appl. No.: 19/427,040

(22) Filed: Dec. 19, 2025

(30) Foreign Application Priority Data
Feb. 11, 2025 (KR) 10-2025-0017030

(51) Int. Cl. G02B 13/00; G02B 9/64

(52) U.S. Cl. CPC G02B 13/0065; G02B 9/64; G02B 13/0045

(57) ABSTRACT

An optical imaging system includes a first lens group including a first lens, a second lens, and a third lens, a second lens group including a fourth lens, a fifth lens, a sixth lens, and a seventh lens, and an optical path folding element disposed between the first lens group and the second lens group, wherein the first to seventh lenses are sequentially disposed in ascending numerical order along an optical axis of the optical imaging system from an object side of the optical imaging system toward an image plane of the optical imaging system, and the first lens has a positive refractive power.

### CROSS-REFERENCE TO RELATED APPLICATIONS

This application claims the benefit under 35 USC 119(a) of Korean Patent Application No. 10-2025-0017030 filed on Feb. 11, 2025, in the Korean Intellectual Property Office, the entire disclosure of which is incorporated herein by reference for all purposes.

### BACKGROUND

### 1. Field

The present disclosure relates to an optical imaging system.

### 2. Description of Background

A camera module may be mounted in an electronic device capable of capturing an image or recording a video. For example, a camera module may be mounted in a mobile phone, a laptop computer, or a game console. However, small electronic devices such as mobile phones, laptop computers, and game consoles generally have a thin body, and thus it may be difficult to mount a camera module having a long focal length.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group including a first lens, a second lens, and a third lens; a second lens group including a fourth lens, a fifth lens, a sixth lens, and a seventh lens; and an optical path folding element disposed between the first lens group and the second lens group, wherein the first to seventh lenses are sequentially disposed in ascending numerical order along an optical axis of the optical imaging system from an object side of the optical imaging system toward an image plane of the optical imaging system, and the first lens has a positive refractive power.

The object-side surface of the first lens may have a convex shape in a paraxial region thereof.

An image-side surface of the second lens may have a concave shape in a paraxial region thereof.

An object-side surface of the third lens may have a convex shape in a paraxial region thereof.

An object-side surface of the fourth lens may have a convex shape in a paraxial region thereof.

An image-side surface of the fifth lens may have a concave shape in a paraxial region thereof.

An object-side surface of the sixth lens may have a convex shape in a paraxial region thereof.

An object-side surface of the seventh lens may have a concave shape in a paraxial region thereof.

The conditional expression 0.30≤fG1/fG2≤2.0 may be satisfied, where fG1 is a focal length of the first lens group, and fG2 is a focal length of the second lens group.

The fourth lens may be a D-cut lens having an object-side surface having a maximum effective diameter, and a minimum effective diameter less than the maximum effective diameter, and the conditional expression 1.0≤h1/h2≤3.0 may be satisfied, where h1 is an effective diameter of an object-side surface of the first lens, and h2 is the minimum effective diameter of the object-side surface of the fourth lens.

The conditional expression 0.30≤SG12/TTL≤1.0 may be satisfied, where SG12 is a distance along the optical axis from an image-side surface of the third lens to an object-side surface of the fourth lens, and TTL is a distance along the optical axis from an object-side surface of the first lens to the image plane.

In another general aspect, an optical imaging system includes a first lens, a second lens, a third lens, a fourth lens, a fifth lens, a sixth lens, and a seventh lens sequentially disposed in ascending numerical order along an optical axis of the optical imaging system from an object side of the optical imaging system toward an image plane of the optical imaging system, wherein an image-side surface of the fifth lens has a concave shape in a paraxial region thereof, and the conditional expression 0.80<D14/D4|<1.0 is satisfied, where D14 is a distance along the optical axis from an object-side surface of the first lens to an object-side surface of the fourth lens, and D4I is a distance along the optical axis from the object-side surface of the fourth lens to the image plane.

The object-side surface of the first lens may have a convex shape in a paraxial region thereof.

An image-side surface of the second lens may have a concave shape in a paraxial region thereof.

An object-side surface of the third lens may have a convex shape in a paraxial region thereof.

The object-side surface of the fourth lens may have a convex shape in a paraxial region thereof.

An object-side surface of the sixth lens may have a convex shape in a paraxial region thereof.

An object-side surface of the seventh lens may have a concave shape in a paraxial region thereof.

The fourth lens may be a D-cut lens, the object-side surface of the fourth lens may have a maximum effective diameter, and a minimum effective diameter less than the maximum effective diameter, and the conditional expression 1.0≤h1/h2≤3.0 may be satisfied, where h1 is an effective diameter of the object-side surface of the first lens, and h2 is the minimum effective diameter of the object-side surface of the fourth lens.

The conditional expression 6.0<TTL/ImgHT<8.0 may be satisfied, where TTL is a distance along the optical axis from an object-side surface of the first lens to the image plane, and ImgHT is one half of a diagonal length of the image plane.

Other features and aspects will be apparent from the following detailed description, the drawings, and the claims.

### BRIEF DESCRIPTION OF DRAWINGS

FIG. 1 is a configuration diagram illustrating an optical imaging system according to a first embodiment of the present disclosure.

FIG. 2 is a graph illustrating aberration curves of the optical imaging system illustrated in FIG. 1.

FIG. 3A is a front view of an incident surface of an optical path folding element (prism) illustrated in FIG. 1.

FIG. 3B is a front view of an exit surface of the optical path folding element (prism) illustrated in FIG. 1.

FIG. 4 is a front view of a lens included in a second lens group illustrated in FIG. 1.

FIG. 5 is a configuration diagram illustrating an optical imaging system according to a second embodiment of the present disclosure.

FIG. 6 is a graph illustrating aberration curves of the optical imaging system illustrated in FIG. 5.

FIG. 7 is a configuration diagram illustrating an optical imaging system according to a third embodiment of the present disclosure.

FIG. 8 is a graph illustrating aberration curves of the optical imaging system illustrated in FIG. 7.

FIG. 9 is a configuration diagram illustrating an optical imaging system according to a fourth embodiment of the present disclosure.

FIG. 10 is a graph illustrating aberration curves of the optical imaging system illustrated in FIG. 9.

FIG. 11 is a configuration diagram illustrating an optical imaging system according to a fifth embodiment of the present disclosure.

FIG. 12 is a graph illustrating aberration curves of the optical imaging system illustrated in FIG. 11.

FIG. 13 is a configuration diagram illustrating an optical imaging system according to a sixth embodiment of the present disclosure.

FIG. 14 is a graph illustrating aberration curves of the optical imaging system illustrated in FIG. 13.

FIG. 15 is a configuration diagram illustrating an optical imaging system according to a seventh embodiment of the present disclosure.

FIG. 16 is a graph illustrating aberration curves of the optical imaging system illustrated in FIG. 15.

FIG. 17 is a configuration diagram illustrating an optical imaging system according to an eighth embodiment of the present disclosure.

FIG. 18 is a graph illustrating aberration curves of the optical imaging system illustrated in FIG. 17.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the drawings, a thickness, a size, and a shape of a lens may be exaggerated for clarity of illustration, and an aspherical shape of a lens is merely an example and is not limited thereto.

As used herein, a first lens may refer to a lens closest to an object (or a subject), and a seventh lens my refer to a lens closest to an image plane (or an image sensor). As used herein, a radius of curvature, a thickness, TTL (a distance from an object-side surface of the first lens to the image plane), ImgHT (an image height, which is one half of a diagonal length of the image plane), a focal length, and an air gap may be represented in millimeters (mm). A field of view (FOV) of an optical imaging system is expressed in degrees.

A thickness of a lens, a distance between lenses (an air gap), and TTL may be measured along an optical axis of an optical imaging system.

In addition, in a description of a shape of a lens, a statement that a surface of the lens has a convex shape means that the surface has a convex shape in a paraxial region of the surface, and a statement that a surface of the lens has a concave shape means that the surface has a convex shape in a paraxial region of the surface. Accordingly, even when it is stated that a surface of the lens has a convex shape, an edge portion of the lens may have a concave shape. Similarly, even when it is stated that a surface of the lens has a concave shape, an edge portion of the lens may have a convex shape.

A paraxial region of a lens surface is a very narrow region around an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos α≈1 are valid.

An optical imaging system according to a first aspect of the present disclosure may include a plurality of lens groups. For example, the optical imaging system according to the first aspect may include a first lens group and a second lens group. In the optical imaging system according to the first aspect, each of the first lens group and the second lens group may include a plurality of lenses. As one example, the first lens group may include a first lens, a second lens, and a third lens, and the second lens group may include a fourth lens, a fifth lens, a sixth lens, and a seventh lens. The first to seventh lenses may be sequentially disposed in ascending numerical order along an optical axis of the optical imaging system from an object side of the optical imaging system toward an image plane of the optical imaging system. The optical imaging system according to the first aspect may include an optical path folding element. For example, the optical imaging system according to the first aspect may include an optical path folding element disposed between the first lens group and the second lens group. The optical path folding element may be configured in the form of a prism or a reflective mirror. The optical imaging system according to the first aspect may include a lens having a positive refractive power. For example, in the optical imaging system according to the first aspect, the first lens may have a positive refractive power.

An optical imaging system according to a second aspect of the present disclosure may include a plurality of lens groups. For example, the optical imaging system according to the second aspect may include a first lens group and a second lens group. In the optical imaging system according to the second aspect, each of the first lens group and the second lens group may include a plurality of lenses. As one example, the first lens group may include a first lens, a second lens, and a third lens, and the second lens group may include a fourth lens, a fifth lens, a sixth lens, and a seventh lens. The first to seventh lenses may be sequentially disposed in ascending numerical order along an optical axis of the optical imaging system from an object side of the optical imaging system toward an image plane of the optical imaging system. The optical imaging system according to the second aspect may include an optical path folding element. For example, the optical imaging system according to the second aspect may include an optical path folding element disposed between the first lens group and the second lens group. The optical path folding element may be configured in the form of a prism or a reflective mirror. The optical imaging system according to the second aspect may include a lens having an image-side surface having a concave shape in a paraxial region thereof. For example, in the optical imaging system according to the second aspect, the fourth lens may have an image-side surface having a concave shape in a paraxial region thereof.

An optical imaging system according to a third aspect of the present disclosure may include a first lens group, an optical path folding element, and a second lens group sequentially disposed along an optical axis of the optical imaging system from an object side of the optical imaging system toward an image plane of the optical imaging system. In the optical imaging system according to the third aspect, the first lens group and the second lens group may include a first lens, a second lens, a third lens, a fourth lens, a fifth lens, a sixth lens, and a seventh lens sequentially disposed in ascending numerical order along the optical axis of the optical imaging system from the object side of the optical imaging system toward the image plane of the optical imaging system. The optical imaging system according to the third aspect may satisfy a specific conditional expression. For example, the optical imaging system according to the third aspect may satisfy any one or any combination of any two or more of the following Conditional Expressions 1 to 6.

$$0.5 \leq \vert f / f 1 \vert + \vert f / f 2 \vert \leq 2. \qquad ( Conditional Expression 1 )$$

$$1. \leq fG 1 / f \leq 3. \qquad ( Conditional Expression 2 )$$

$$0.3 \leq fG 1 / fG 2 \leq 2. \qquad ( Conditional Expression 3 )$$

$$1. \leq h 1 / h 2 \leq 3. \qquad ( Conditional Expression 4 )$$

$$0.3 \leq SG 12 / TTL \leq 1. \qquad ( Conditional Expression 5 )$$

$$0.5 mm \leq h 2 / ( f - number ) \leq 2. mm \qquad ( Conditional Expression 6 )$$

In the above conditional expressions, f may be a focal length of the optical imaging system, fG1 may be a focal length of the first lens group, fG2 may be a focal length of the second lens group, f1 may be a focal length of the first lens, f2 may be a focal length of the second lens, h1 may be an effective diameter of an object-side surface of a frontmost lens of the first lens group, h2 may be a minimum effective diameter of an object-side of a frontmost lens of the second lens group, SG12 may be a distance along the optical axis between the first lens group and the second lens group, which is a distance along the optical axis from an image-side surface of a rearmost lens of the first lens group to an object-side surface of the frontmost lens of the second lens group, TTL may be a distance along the optical axis from an object-side surface of the first lens to the image plane, and f-number may be an f-number of the optical imaging system, which is equal to the focal length f of the optical imaging system divided by an entrance pupil diameter of the optical imaging system.

Conditional Expression 1 may be a numerical range for limiting refractive powers of the first lens and the second lens to reduce an aberration of the optical imaging system. For example, the first lens and/or the second lens deviating from the numerical range of Conditional Expression 11 may increase the aberration of the optical imaging system. Conditional Expressions 2 and 3 may be numerical ranges for implementing a high resolution of the optical imaging system. For example, the optical imaging system deviating from the numerical range of Conditional Expression 2 or 3 may make it difficult to implement a high resolution. Conditional Expressions 4 and 5 may be numerical ranges for achieving miniaturization and thinning of the optical imaging system. For example, the optical imaging system deviating from the numerical range of Conditional Expression 4 or 5 may make it difficult to achieve miniaturization and thinning. Conditional Expression 6 may be a numerical range for achieving thinning and implementing a high resolution of a telephoto optical imaging system. For example, the optical imaging system deviating from an upper limit value of Conditional Expression 6 may make it difficult to achieve thinning, and the optical imaging system deviating from a lower limit value of Conditional Expression 6 may make it difficult to achieve a high resolution or a low f-number.

An optical imaging system according to a fourth aspect of the present disclosure may include a plurality of lenses. For example, the optical imaging system according to the fourth aspect may include a first lens, a second lens, a third lens, a fourth lens, a fifth lens, a sixth lens, and a seventh lens sequentially disposed in ascending numerical order along an optical axis of the optical imaging system from an object side of the optical imaging system toward an image plane of the optical imaging system. The optical imaging system according to the fourth aspect may include a lens having an image-side surface having a concave shape in a paraxial region thereof. For example, in the optical imaging system according to the fourth aspect, the fifth lens may have an image-side surface having a concave shape in a paraxial region thereof. The optical imaging system according to the fourth aspect may satisfy a specific conditional expression. For example, the optical imaging system according to the fourth aspect may satisfy a conditional expression of 0.80<D14/D4I<1.0. In the conditional expression, D14 may be a distance along the optical axis from an object-side surface of the first lens to an object-side surface of the fourth lens, and D4 may be a distance along the optical axis from the object-side surface of the fourth lens to the image plane.

An optical imaging system according to a fifth aspect of the present disclosure may include a first lens, a second lens, a third lens, a fourth lens, a fifth lens, a sixth lens, and a seventh lens sequentially disposed in ascending numerical order along an optical axis of the optical imaging system from an object side of the optical imaging system toward an image plane of the optical imaging system, and may satisfy any one or any combination of any two or more of the following Conditional Expressions 7 to 20.

$$1. < f 1 / f < 1.6 \qquad ( Conditional Expression 7 )$$

$$- 3. < f 2 / f < - 1.2 \qquad ( Conditional Expression 8 )$$

$$2. 0 < f 3 / f < 12. \qquad ( Conditional Expression 9 )$$

$$0.1 < f 4 / f < 0.60 \qquad ( Conditional Expression 10 )$$

$$- 0.4 < f 5 / f < - 0.10 \qquad ( Conditional Expression 11 )$$

$$0.1 < f 6 / f < 0.4 \qquad ( Conditional Expression 12 )$$

$$- 0.6 < f 7 / f < - 0 \text{.10} \qquad ( Conditional Expression 13 )$$

$$- 1.6 < f 4 / f 5 < - 1.2 \qquad ( Conditional Expression 14 )$$

$$- 1. < f 5 / f 6 < - 0.60 \qquad ( Conditional Expression 15 )$$

$$- 1.2 < f 4 / f 7 < - 0.80 \qquad ( Conditional Expression 16 )$$

$$- 1. < f 6 / f 7 < - 0.60 \qquad ( Conditional Expression 17 )$$

$$1. < TTL / f < 1.4 \qquad ( Conditional Expression 18 )$$

$$0.3 < BFL / f < 0.5 \qquad ( Conditional Expression 19 )$$

$$6. < TTL / ImgHT < 8. \qquad ( Conditional Expression 20 )$$

In the above conditional expressions, f3 may be a focal length of the third lens, f4 may be a focal length of the fourth lens, f5 may be a focal length of the fifth lens, f6 may be a focal length of the sixth lens, f7 may be a focal length of the seventh lens, BFL may be a distance along the optical axis from an image-side surface of the seventh lens (or a rearmost lens of the optical imaging system) to the image plane, and ImgHT may be an image height, which is one half of a diagonal length of the image plane. In the drawings, ImgHT is shown as IMG HT. The above conditional expressions may provide numerical ranges for optimizing a refractive power distribution of the first to seventh lenses and a length of the optical imaging system. As one example, an optical imaging system not satisfying the above conditional expressions may have first to seventh lenses having an excessively strong or weak refractive power. As a result, aberration improvement may be difficult. As another example, an optical imaging system not satisfying the above conditional expressions may have an excessively large or small TTL or BFL. As a result, achieving miniaturization and thinning may be difficult.

An optical imaging system according to a sixth aspect of the present disclosure may include a first lens, a second lens, a third lens, a fourth lens, a fifth lens, a sixth lens, and a seventh lens sequentially disposed in ascending numerical order along an optical axis of the optical imaging system from an object side of the optical imaging system toward an image plane of the optical imaging system, and may satisfy one or more of the following Conditional Expressions 21 to 25.

$$1.6 < R 1 / R 7 < 3. \qquad ( Conditional Expression 21 )$$

$$2. 0 < R 1 / R 10 < 4. \qquad ( Conditional Expression 22 )$$

$$0. 60 < R 1 / R 14 < 1.2 \qquad ( Conditional Expression 23 )$$

$$1. < R 7 / R 10 < 1.6 \qquad ( Conditional Expression 24 )$$

$$0.3 < R 10 / R 11 < 0.6 \qquad ( Conditional Expression 25 )$$

In the above conditional expressions, R1 may be a radius of curvature of an object-side surface of the first lens at the optical axis, R7 may be a radius of curvature of an object-side surface of the fourth lens at the optical axis, R10 may be a radius of curvature of an image-side surface of the fifth lens at the optical axis, R11 may be a radius of curvature of an object-side surface of the sixth lens at the optical axis, and R14 may be a radius of curvature of an image-side surface of the seventh lens at the optical axis. The above conditional expressions may provide shapes of the first lens and the fifth to seventh lenses for improving an aberration of the optical imaging system.

An optical imaging system according to a seventh aspect of the present disclosure may include two or more of the features of the optical imaging systems according to the first to sixth aspects. As one example, the optical imaging system according to the seventh aspect may include a feature of the first aspect, and may satisfy any one or any combination of any two or more of Conditional Expressions 1 to 6 of the third aspect. As another example, the optical imaging system according to the seventh aspect may include a feature of the first aspect, and may satisfy any one or any combination of any two or more of Conditional Expressions 7 to 20 according to the fifth aspect.

The optical imaging systems according to the first to seventh aspects may include one or more lenses having the following features as needed. As one example, the optical imaging systems according to the first aspect may include one lens among the first to seventh lenses having the following features. As another example, the optical imaging system according to the second aspect may include two or more lenses among the first to seventh lenses having the following features. However, the optical imaging systems according to the above-described aspects may not necessarily include lenses having the following features. Hereinafter, features of the first to seventh lenses are described.

The first lens may have a refractive power. For example, the first lens may have a positive refractive power. One surface of the first lens may have a convex shape in a paraxial region thereof. For example, an object-side surface of the first lens may have a convex shape in a paraxial region thereof. The first lens may have an aspherical shape. For example, both the object-side surface and an image-side surface of the first lens may have an aspherical shape. The first lens may be made of a material having a high light transmittance and an excellent processability. For example, the first lens may be made of a glass material or a plastic material. The first lens may have a predetermined refractive index. For example, the first lens may have a refractive index of 1.5 or more. The first lens may have a predetermined Abbe number. For example, the first lens may have an Abbe number of 50 or more. The first lens may have a focal length within a predetermined range. For example, the focal length of the first lens may be within a range of 18 mm to 32 mm.

The second lens may have a refractive power. For example, the second lens may have a negative refractive power. One surface of the second lens may have a concave shape in a paraxial region thereof. For example, an image-side surface of the second lens may have a concave shape in a paraxial region thereof. The second lens may have an aspherical shape. For example, both an object-side surface and the image-side surface of the second lens may have an aspherical shape. The second lens may be made of a material having a high light transmittance and an excellent processability. For example, the second lens may be made of a glass material or a plastic material. The second lens may have a predetermined refractive index. For example, the second lens may have a refractive index greater than a refractive index of the first lens or equal to the refractive index of the first lens. The second lens may have a predetermined Abbe number. For example, the second lens may have an Abbe number of 20 or more. The second lens may have a focal length within a predetermined range. For example, the focal length of the second lens may be within a range of −60 mm to −20 mm.

The third lens may have a refractive power. For example, the third lens may have a positive refractive power. One surface of the third lens may have a convex shape in a paraxial region thereof. For example, an object-side surface of the third lens may have a convex shape in a paraxial region thereof. The third lens may have an aspherical shape. For example, both the object-side surface and an image-side surface the third lens may have an aspherical shape. The third lens may be made of a material having a high light transmittance and an excellent processability. For example, the third lens may be made of a glass material or a plastic material. The third lens may have a predetermined refractive index. For example, the third lens may have a refractive index of 1.5 or more. The third lens may have a predetermined Abbe number. For example, the third lens may have an Abbe number of 20 or more. The third lens may have a focal length within a predetermined range. For example, the focal length of the third lens may be within a range of 40 mm to 200 mm.

The fourth lens may have a refractive power. For example, the fourth lens may have a positive refractive power. One surface of the fourth lens may have a convex shape in a paraxial region thereof. For example, an object-side surface of the fourth lens may have a convex shape in a paraxial region thereof. The fourth lens may have an aspherical shape. For example, both the object-side surface and an image-side surface the fourth lens may have an aspherical shape. The fourth lens may be made of a material having a high light transmittance and an excellent processability. For example, the fourth lens may be made of a glass material or a plastic material. The fourth lens may have a predetermined refractive index. For example, the fourth lens may have a refractive index of 1.5 or more. The fourth lens may have a predetermined Abbe number. For example, the fourth lens may have an Abbe number of 50 or more.

The fifth lens may have a refractive power. For example, the fifth lens may have a negative refractive power. One surface of the fifth lens may have a concave shape in a paraxial region thereof. For example, an image-side surface of the fifth lens may have a concave shape in a paraxial region thereof. The fifth lens may have an aspherical shape. For example, both an object-side surface and the image-side surface of the fifth lens may have an aspherical shape. The fifth lens may be made of a material having a high light transmittance and an excellent processability. For example, the fifth lens may be made of a glass material or a plastic material. The fifth lens may have a predetermined refractive index. For example, the fifth lens may have a refractive index of 1.6 or more. The fifth lens may have a predetermined Abbe number. For example, the fifth lens may have an Abbe number of 20 or more. The fifth lens may have a focal length within a predetermined range. For example, the focal length of the fifth lens may be within a range of −6.0 mm to −3.0 mm.

The sixth lens may have a refractive power. For example, the sixth lens may have a positive refractive power. One surface of the sixth lens may have a convex shape in a paraxial region thereof. For example, an object-side surface of the sixth lens may have a convex shape in a paraxial region thereof. The sixth lens may have an aspherical shape. For example, both the object-side surface and an image-side surface of the sixth lens may have an aspherical shape. The sixth lens may be made of a material having a high light transmittance and an excellent processability. For example, the sixth lens may be made of a glass material or a plastic material. The sixth lens may have a predetermined refractive index. For example, the sixth lens may have a refractive index of 1.6 or more. The sixth lens may have a predetermined Abbe number. For example, the sixth lens may have an Abbe number of 20 or more. The sixth lens may have a focal length within a predetermined range. For example, the focal length of the sixth lens may be within a range of 4.0 mm to 8.0 mm.

The seventh lens may have a refractive power. For example, the seventh lens may have a negative refractive power. One surface of the seventh lens may have a concave shape in a paraxial region thereof. For example, an object-side surface of the seventh lens may have a concave shape in a paraxial region thereof. The seventh lens may have an aspherical shape. For example, both the object-side surface and an image-side surface of the seventh lens may have an aspherical shape. The seventh lens may be made of a material having a high light transmittance and an excellent processability. For example, the seventh lens may be made of a glass material or a plastic material. The seventh lens may have a predetermined refractive index. For example, the seventh lens may have a refractive index of 1.6 or more. The seventh lens may have a predetermined Abbe number. For example, the seventh lens may have an Abbe number of 20 or more. The seventh lens may have a focal length within a predetermined range. For example, the focal length of the seventh lens may be within a range of −10 mm to −6.0 mm.

The aspherical surfaces of the first to seventh lenses included in the optical imaging system may be represented by Equation 1 below.

$$Z = \frac{{cr}^{2}}{1 + \sqrt{1 - ( 1 + k ) {c}^{2} {r}^{2}}} + A {r}^{4} + B {r}^{6} + {Cr}^{8} + {Dr}^{10} + E {r}^{12} + {Fr}^{14} + {Gr}^{16} + {Hr}^{18} + {Jr}^{20} … \qquad ( 1 )$$

In Equation 1, c is a curvature of the lens surface and is equal to a reciprocal of a radius of curvature of the lens surface at an optical axis of the lens surface, k is a conic constant, and r is a distance from any point on the aspherical surface of the lens to the optical axis. In addition, constants A to H and J are aspherical surface coefficients. Z (also known as sag) is a distance in a direction parallel to an optical axis direction between the point on the aspherical surface of the lens at the distance r from the optical axis of the aspherical surface to a tangential plane perpendicular to the optical axis and intersecting a vertex of the aspherical surface.

The optical imaging system may include an image plane and a filter. The image plane may be formed at a position at which light refracted by the first to seventh lenses is focused to form an image. The image plane may be formed by an image sensor. For example, the image plane may be formed on a surface of the image sensor or inside the image sensor. The filter may be disposed between the seventh lens and the image plane. The filter may block light having some wavelengths. For example, the filter may block light having an infrared wavelength.

Hereinafter, embodiments of the present disclosure will be described in detail with reference to the accompanying drawings.

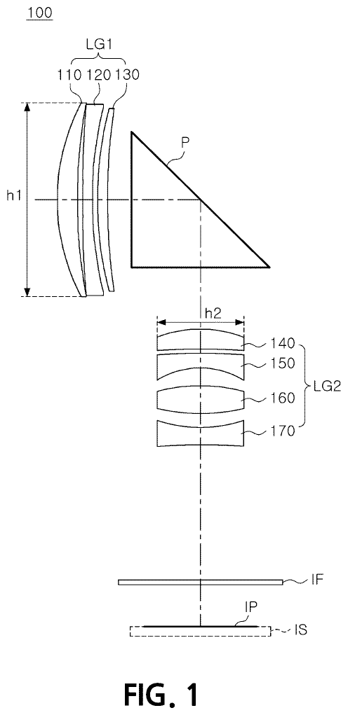

FIG. 1 is a configuration diagram illustrating an optical imaging system according to a first embodiment of the present disclosure.

Referring to FIG. 1, an optical imaging system 100 may include a plurality of lens groups. For example, the optical imaging system 100 may include a first lens group LG1 and a second lens group LG2 sequentially disposed in ascending numerical order along an optical axis of the optical imaging system 100 from an object side of the optical imaging system 100 toward an image plane of the optical imaging system 100. The first lens group LG1 and the second lens group LG2 each may be formed of a plurality of lenses. As one example, the first lens group LG1 may be formed of a first lens 110, a second lens 120, and a third lens 130, and the second lens group LG2 may be formed of a fourth lens 140, a fifth lens 150, a sixth lens 160, and a seventh lens 170. However, the lenses included in the first lens group LG1 and the second lens group LG2 are not limited to the above-described lenses.

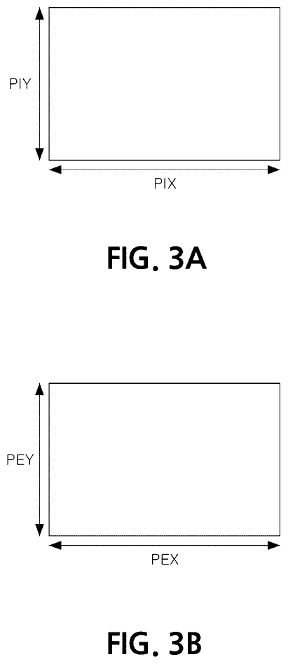

The optical imaging system 100 may include an optical path folding element P. For example, the optical imaging system 100 may include an optical path folding element P in the form of a prism disposed between the first lens group LG1 and the second lens group LG2. In the optical imaging system 100 according to the present embodiment, the optical path folding element P may be configured so that lengths PIX and PEX in a first direction intersecting an optical axis, and lengths PIY and PEY in a second direction intersecting the optical axis, are different from each other as illustrated in FIGS. 3A and 3B. For example, an incident surface of the optical path folding element P may be formed so that a length PIX of the incident surface in the first direction intersecting the optical axis is greater than a length PIY of the incident surface in the second direction intersecting the optical axis, and an exit surface of the optical path folding element P may be formed so that a length PEX of the exit surface in the first direction intersecting the optical axis is greater than a length PEY of the exit surface in the second direction intersecting the optical axis.

Hereinafter, optical characteristics of the lenses included in the first lens group LG1 and the second lens group LG2 will be described.

The first lens 110 may have a positive refractive power, and may have an object-side surface having a convex shape in a paraxial region thereof, and an image-side surface having a concave shape in a paraxial region thereof. The second lens 120 may have a negative refractive power, and may have an object-side surface having a convex shape in a paraxial region thereof, and an image-side surface having a concave shape in a paraxial region thereof. The third lens 130 may have a positive refractive power, and may have an object-side surface having a convex shape in a paraxial region thereof, and an image-side surface having a concave shape in a paraxial region thereof. The fourth lens 140 may have a positive refractive power, and may have an object-side surface having a convex shape in a paraxial region thereof, and an image-side surface having a concave shape in a paraxial region thereof. The fifth lens 150 may have a negative refractive power, and may have an object-side surface having a convex shape in a paraxial region thereof, and an image-side surface having a concave shape in a paraxial region thereof. The sixth lens 160 may have a positive refractive power, and may have an object-side surface having a convex shape in a paraxial region thereof, and an image-side surface having a convex shape in a paraxial region thereof. The seventh lens 170 may have a negative refractive power, and may have an object-side surface having a concave shape in a paraxial region thereof, and an image-side surface having a concave shape in a paraxial region thereof.

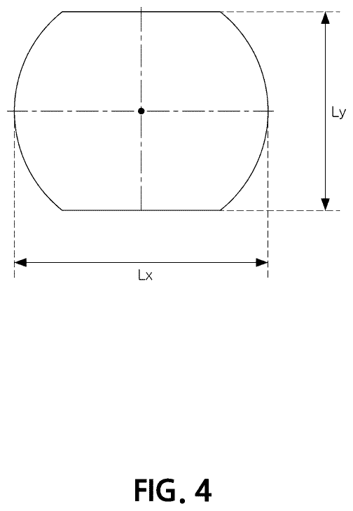

In the optical imaging system 100, some lenses may be configured so that an effective diameter Lx in the first direction intersecting an optical axis, and an effective diameter Ly in the second direction intersecting the optical axis, are different from each other. For example, as illustrated in FIG. 4, the lenses included in the second lens group LG2 in the optical imaging system 100 may be lenses having a D-cut shape in which a portion of a lens is cut away.

The optical imaging system 100 may further include a filter IF and an image plane IP. The image plane IP may be formed on an image sensor IS, and the filter IF may be disposed between the seventh lens 170 and the image plane IP.

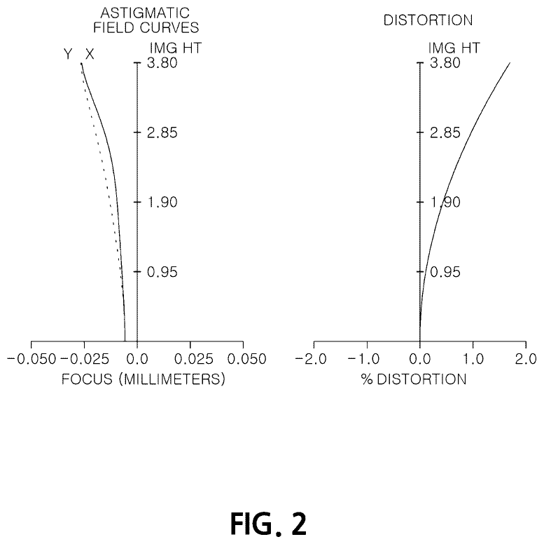

FIG. 2 is a graph illustrating aberration curves of the optical imaging system illustrated in FIG. 1.

Table 1 below lists characteristics of each of the lenses and other elements included in the optical imaging system 100 according to the first embodiment.

TABLE 1

| Surface | | Radius of | Thickness/ | Refractive | Abbe | Effective | Effective |
|---|---|---|---|---|---|---|---|
| No. | Element | Curvature | Distance | Index | Number | Radius X | Radius Y |
| S1 | First | 9.067 | 0.802 | 1.535 | 55.7 | 4.000 | 4.000 |
| S2 | Lens | 25.277 | 0.162 | | | 3.957 | 3.957 |
| S3 | Second | 50.281 | 0.415 | 1.614 | 25.9 | 3.956 | 3.956 |
| S4 | Lens | 17.898 | 0.180 | | | 3.826 | 3.826 |
| S5 | Third | 13.574 | 0.471 | 1.535 | 55.7 | 3.782 | 3.782 |
| S6 | Lens | 26.297 | 0.970 | | | 3.742 | 3.742 |
| S7 | Prism | Infinity | 2.800 | 1.717 | 29.5 | 4.000 | 2.800 |
| S8 | | Infinity | 2.800 | 1.717 | 29.5 | 4.000 | 4.383 |
| S9 | | Infinity | 1.700 | | | 4.000 | 2.800 |
| S10 | Fourth | 3.733 | 1.000 | 1.535 | 55.7 | 2.300 | 1.750 |
| S11 | Lens | 1015.317 | 0.100 | | | 2.271 | 1.750 |
| | (Aperture) | | | | | | |
| S12 | Fifth | 98.777 | 0.525 | 1.614 | 25.9 | 2.229 | 1.750 |
| S13 | Lens | 2.892 | 0.795 | | | 1.876 | 1.750 |
| S14 | Sixth | 6.783 | 1.200 | 1.661 | 20.4 | 2.021 | 1.750 |
| S15 | Lens | −8.551 | 0.570 | | | 2.039 | 1.750 |
| S16 | Seventh | −7.514 | 0.731 | 1.639 | 23.5 | 1.928 | 1.750 |
| S17 | Lens | 11.652 | 4.661 | | | 2.064 | 1.750 |
| S18 | Filter | Infinity | 0.210 | 1.517 | 64.2 | | |
| S19 | | Infinity | 2.349 | | | | |
| S20 | Image | Infinity | 0.006 | | | | |
| | Plane | | | | | | |

Table 2 below lists a conic constant k and aspherical surface coefficients A to H and J of each of the lenses included in the optical imaging system 100 according to the first embodiment.

TABLE 2

| Surface | | | | | | | |
|---|---|---|---|---|---|---|---|
| No. | S1 | S2 | S3 | S4 | S5 | S6 | S10 |
| k | −2.979E−01 | 1.408E+01 | −6.320E+01 | −3.891E+00 | 2.062E−02 | −2.341E−01 | 0.000E+00 |
| A | −4.167E−05 | −4.832E−05 | 3.944E−05 | −3.357E−05 | 1.227E−06 | −1.659E−06 | 8.197E−04 |
| B | 8.070E−07 | −1.869E−06 | 7.953E−07 | 5.466E−06 | −2.754E−08 | 3.114E−08 | −1.009E−04 |
| C | 1.796E−07 | −1.357E−07 | 4.429E−08 | 3.802E−07 | −9.515E−10 | 4.179E−09 | −7.794E−06 |
| D | 0 | 0 | 0 | 0 | 0 | 0 | 1.201E−06 |
| E | 0 | 0 | 0 | 0 | 0 | 0 | 0 |
| F | 0 | 0 | 0 | 0 | 0 | 0 | 0 |
| G | 0 | 0 | 0 | 0 | 0 | 0 | 0 |
| H | 0 | 0 | 0 | 0 | 0 | 0 | 0 |
| J | 0 | 0 | 0 | 0 | 0 | 0 | 0 |

| Surface | | | | | | | |
|---|---|---|---|---|---|---|---|
| No. | S11 | S12 | S13 | S14 | S15 | S16 | S17 |
| k | 3.707E−02 | −5.828E+00 | −1.304E+00 | 2.897E−02 | 1.815E+00 | 0.000E+00 | 1.598E+01 |
| A | 1.067E−02 | −4.039E−04 | −6.951E−02 | 1.156E−05 | 2.873E−02 | −8.873E−03 | −1.010E−02 |
| B | −4.817E−03 | 7.124E−06 | 1.499E−01 | 4.286E−06 | −5.927E−02 | −5.115E−04 | 7.383E−04 |
| C | 1.393E−03 | −5.733E−06 | −3.735E−02 | 1.352E−06 | −1.896E−02 | 7.374E−05 | −1.301E−05 |
| D | −3.669E−04 | −4.636E−06 | −2.072E−01 | 2.730E−07 | 7.289E−02 | 6.075E−06 | −1.962E−06 |
| E | 7.867E−05 | 0 | 5.716E−01 | 3.134E−08 | −1.183E−01 | 4.536E−07 | 0 |
| F | −1.175E−05 | 0 | −7.754E−01 | 3.914E−09 | 1.236E−01 | 0 | 0 |
| G | 9.934E−07 | 0 | 6.025E−01 | 4.307E−20 | −8.066E−02 | 0 | 0 |
| H | −2.963E−08 | 0 | −2.539E−01 | −3.207E−21 | 3.014E−02 | 0 | 0 |
| J | −7.374E−10 | 0 | 4.491E−02 | 5.808E−23 | −4.996E−03 | 0 | 0 |

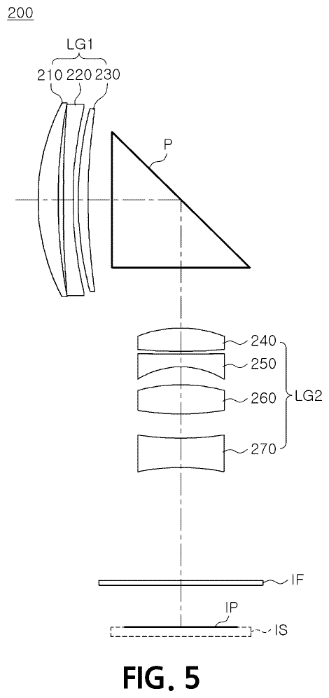

FIG. 5 is a configuration diagram illustrating an optical imaging system according to a second embodiment of the present disclosure.

Referring to FIG. 5, an optical imaging system 200 may include a plurality of lens groups. For example, the optical imaging system 200 may include a first lens group LG1 and a second lens group LG2 sequentially disposed in ascending numerical order along an optical axis of the optical imaging system 200 from an object side of the optical imaging system 200 toward an image plane of the optical imaging system 200. The first lens group LG1 and the second lens group LG2 each may be formed of a plurality of lenses. As one example, the first lens group LG1 may be formed of a first lens 210, a second lens 220, and a third lens 230, and the second lens group LG2 may be formed of a fourth lens 240, a fifth lens 250, a sixth lens 260, and a seventh lens 270. However, the lenses included in the first lens group LG1 and the second lens group LG2 are not limited to the above-described lenses.

The optical imaging system 200 may include an optical path folding element P. For example, the optical imaging system 200 may include an optical path folding element P in the form of a prism disposed between the first lens group LG1 and the second lens group LG2. In the optical imaging system 200 according to the present embodiment, the optical path folding element P may be configured so that lengths PIX and PEX in a first direction intersecting an optical axis, and lengths PIY and PEY in a second direction intersecting the optical axis, are different from each other as illustrated in FIGS. 3A and 3B. For example, an incident surface of the optical path folding element P may be formed so that a length PIX of the incident surface in the first direction intersecting the optical axis is greater than a length PIY of the incident surface in the second direction intersecting the optical axis, and an exit surface of the optical path folding element P may be formed so that a length PEX of the exit surface in the first direction intersecting the optical axis is greater than a length PEY of the exit surface in the second direction intersecting the optical axis.

Hereinafter, optical characteristics of the lenses included in the first lens group LG1 and the second lens group LG2 will be described.

The first lens 210 may have a positive refractive power, and may have an object-side surface having a convex shape in a paraxial region thereof, and an image-side surface having a concave shape in a paraxial region thereof. The second lens 220 may have a negative refractive power, and may have an object-side surface having a convex shape in a paraxial region thereof, and an image-side surface having a concave shape in a paraxial region thereof. The third lens 230 may have a positive refractive power, and may have an object-side surface having a convex shape in a paraxial region thereof, and an image-side surface having a concave shape in a paraxial region thereof. The fourth lens 240 may have a positive refractive power, and may have an object-side surface having a convex shape in a paraxial region thereof, and an image-side surface having a convex shape in a paraxial region thereof. The fifth lens 250 may have a negative refractive power, and may have an object-side surface having a concave shape in a paraxial region thereof, and an image-side surface having a concave shape in a paraxial region thereof. The sixth lens 260 may have a positive refractive power, and may have an object-side surface having a convex shape in a paraxial region thereof, and an image-side surface having a convex shape in a paraxial region thereof. The seventh lens 270 may have a negative refractive power, and may have an object-side surface having a concave shape in a paraxial region thereof, and an image-side surface having a concave shape in a paraxial region thereof.

In the optical imaging system 200, some lenses may be configured so that an effective diameter Lx in the first direction intersecting the optical axis, and an effective diameter Ly in the second direction intersecting the optical axis, are different from each other. For example, as illustrated in FIG. 4, the lenses included in the second lens group LG2 in the optical imaging system 200 may be lenses having a D-cut shape in which a portion of a lens is cut away.

The optical imaging system 200 may further include a filter IF and an image plane IP. The image plane IP may be formed on an image sensor IS, and the filter IF may be disposed between the seventh lens 270 and the image plane IP.

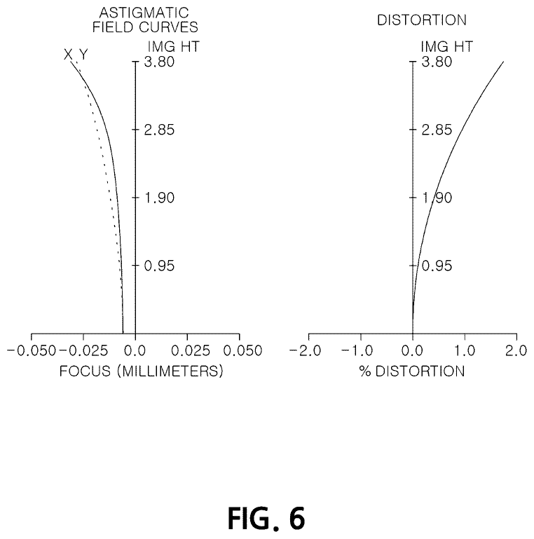

FIG. 6 is a graph illustrating aberration curves of the optical imaging system illustrated in FIG. 5.

Table 3 below lists characteristics of each of the lenses and other elements included in the optical imaging system 200 according to the second embodiment.

TABLE 3

| Surface | | Radius of | Thickness/ | Refractive | Abbe | Effective | Effective |
|---|---|---|---|---|---|---|---|
| No. | Element | Curvature | Distance | Index | Number | Radius X | Radius Y |
| S1 | First | 8.637 | 0.817 | 1.535 | 55.7 | 4.000 | 4.000 |
| S2 | Lens | 22.775 | 0.205 | | | 3.956 | 3.956 |
| S3 | Second | 44.218 | 0.400 | 1.614 | 25.9 | 3.955 | 3.955 |
| S4 | Lens | 16.202 | 0.211 | | | 3.820 | 3.820 |
| S5 | Third | 15.528 | 0.403 | 1.535 | 55.7 | 3.783 | 3.783 |
| S6 | Lens | 26.589 | 0.964 | | | 3.745 | 3.745 |
| S7 | Prism | Infinity | 2.800 | 1.717 | 29.5 | 4.000 | 2.800 |
| S8 | | Infinity | 2.800 | 1.717 | 29.5 | 4.000 | 4.383 |
| S9 | | Infinity | 2.498 | | | 4.000 | 2.800 |
| S10 | Fourth | 4.734 | 0.970 | 1.535 | 55.7 | 2.300 | 1.750 |
| S11 | Lens | −13.580 | 0.100 | | | 2.293 | 1.750 |
| | (Aperture) | | | | | | |
| S12 | Fifth | −209.201 | 0.532 | 1.614 | 25.9 | 2.186 | 1.750 |
| S13 | Lens | 3.068 | 0.743 | | | 1.875 | 1.750 |
| S14 | Sixth | 6.874 | 1.200 | 1.661 | 20.4 | 2.031 | 1.750 |
| S15 | Lens | −9.848 | 1.015 | | | 2.063 | 1.750 |
| S16 | Seventh | −9.536 | 1.200 | 1.639 | 23.5 | 1.978 | 1.750 |
| S17 | Lens | 9.168 | 4.661 | | | 2.028 | 1.750 |
| S18 | Filter | Infinity | 0.210 | 1.517 | 64.2 | | |
| S19 | | Infinity | 1.727 | | | | |
| S20 | Image | Infinity | 0.006 | | | | |
| | Plane | | | | | | |

Table 4 below lists a conic constant k and aspherical surface coefficients A to H and J of each of the lenses included in the optical imaging system 200 according to the second embodiment.

TABLE 4

| Surface | | | | | | | |
|---|---|---|---|---|---|---|---|
| No. | S1 | S2 | S3 | S4 | S5 | S6 | S10 |
| k | −1.167E−01 | 1.440E+01 | −9.377E+01 | −3.324E+00 | 1.606E−02 | −7.529E−02 | 0.000E+00 |
| A | 7.478E−06 | −7.340E−05 | −1.397E−05 | −2.332E−05 | 4.561E−07 | −3.821E−07 | 5.354E−04 |
| B | −2.670E−07 | −3.476E−06 | −1.204E−06 | 2.563E−06 | 9.777E−08 | −1.328E−07 | −1.577E−04 |
| C | −4.703E−08 | −2.530E−07 | 1.190E−08 | 1.950E−07 | 1.621E−08 | −2.089E−08 | −1.839E−05 |
| D | 0 | 0 | 0 | 0 | −3.992E−10 | 4.418E−10 | −2.140E−07 |
| E | 0 | 0 | 0 | 0 | 0 | 0 | 0 |
| F | 0 | 0 | 0 | 0 | 0 | 0 | 0 |
| G | 0 | 0 | 0 | 0 | 0 | 0 | 0 |
| H | 0 | 0 | 0 | 0 | 0 | 0 | 0 |
| J | 0 | 0 | 0 | 0 | 0 | 0 | 0 |

| Surface | | | | | | | |
|---|---|---|---|---|---|---|---|
| No. | S11 | S12 | S13 | S14 | S15 | S16 | S17 |
| k | 3.707E−02 | 9.900E+01 | −1.245E+00 | 4.562E−02 | −3.971E+00 | 1.353E+01 | 0.000E+00 |
| A | 6.765E−01 | −4.129E−04 | −2.463E−01 | 1.674E−05 | 1.206E−01 | 7.858E−03 | 2.072E−03 |
| B | −2.779E+00 | 2.287E−05 | 1.346E+00 | 7.612E−06 | −2.108E−01 | −8.447E−04 | −4.906E−04 |
| C | 8.830E+00 | 1.424E−06 | −1.809E+00 | 5.614E−08 | −1.508E−01 | 3.949E−05 | 6.172E−07 |
| D | −2.713E+01 | −1.922E−06 | −3.011E+00 | −1.658E−07 | −3.363E−01 | 1.855E−05 | 1.524E−05 |
| E | 6.796E+01 | 0.000E+00 | 3.403E+01 | −4.252E−09 | 3.465E+00 | 0 | −1.318E−06 |
| F | −1.210E+02 | 0 | −1.172E+02 | 1.230E−08 | −1.004E+01 | 0 | 0 |
| G | 1.398E+02 | 0 | 2.123E+02 | 4.841E−09 | 1.515E+01 | 0 | 0 |
| H | −9.339E+01 | 0 | −2.026E+02 | 2.882E−20 | −1.118E+01 | 0 | 0 |
| J | 2.729E+01 | 0 | 8.015E+01 | 7.115E−22 | 3.050E+00 | 0 | 0 |

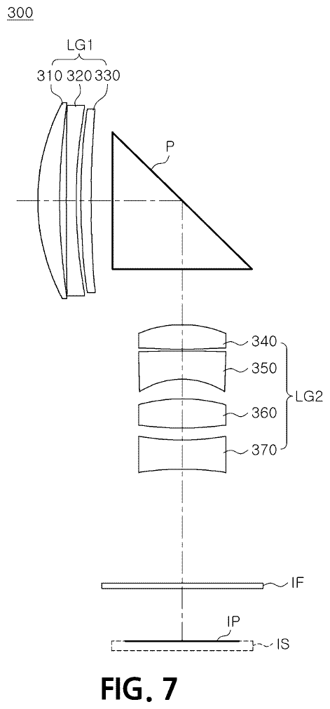

FIG. 7 is a configuration diagram illustrating an optical imaging system according to a third embodiment of the present disclosure.

Referring to FIG. 7, an optical imaging system 300 may include a plurality of lens groups. For example, the optical imaging system 300 may include a first lens group LG1 and a second lens group LG2 sequentially disposed in ascending numerical order along an optical axis of the optical imaging system 300 from an object side of the optical imaging system 300 toward an image plane of the optical imaging system 300. The first lens group LG1 and the second lens group LG2 each may be formed of a plurality of lenses. As one example, the first lens group LG1 may be formed of a first lens 310, a second lens 320, and a third lens 330, and the second lens group LG2 may be formed of a fourth lens 340, a fifth lens 350, a sixth lens 360, and a seventh lens 370. However, the lenses included in the first lens group LG1 and the second lens group LG2 are not limited to the above-described lenses.

The optical imaging system 300 may include an optical path folding element P. For example, the optical imaging system 300 may include an optical path folding element P in the form of a prism disposed between the first lens group LG1 and the second lens group LG2. In the optical imaging system 300 according to the present embodiment, the optical path folding element P may be configured so that lengths PIX and PEX in a first direction intersecting an optical axis, and lengths PIY and PEY in a second direction intersecting the optical axis, are different from each other as illustrated in FIGS. 3A and 3B. For example, an incident surface of the optical path folding element P may be formed so that a length PIX of the incident surface in the first direction intersecting the optical axis is greater than a length PIY of the incident surface in the second direction intersecting the optical axis, and an exit surface of the optical path folding element P may be formed so that a length PEX of the exit surface in the first direction intersecting the optical axis is greater than a length PEY of the exit surface in the second direction intersecting the optical axis.

Hereinafter, optical characteristics of the lenses included in the first lens group LG1 and the second lens group LG2 will be described.

The first lens 310 may have a positive refractive power, and may have an object-side surface having a convex shape in a paraxial region thereof, and an image-side surface having a concave shape in a paraxial region thereof. The second lens 320 may have a negative refractive power, and may have an object-side surface having a convex shape in a paraxial region thereof, and an image-side surface having a concave shape in a paraxial region thereof. The third lens 330 may have a positive refractive power, and may have an object-side surface having a convex shape in a paraxial region thereof, and an image-side surface having a concave shape in a paraxial region thereof. The fourth lens 340 may have a positive refractive power, and may have an object-side surface having a convex shape in a paraxial region thereof, and an image-side surface having a convex shape in a paraxial region thereof. The fifth lens 350 may have a negative refractive power, and may have an object-side surface having a convex shape in a paraxial region thereof, and an image-side surface having a concave shape in a paraxial region thereof. The sixth lens 360 may have a positive refractive power, and may have an object-side surface having a convex shape in a paraxial region thereof, and an image-side surface having a convex shape in a paraxial region thereof. The seventh lens 370 may have a negative refractive power, and may have an object-side surface having a concave shape in a paraxial region thereof, and an image-side surface having a concave shape in a paraxial region thereof.

In the optical imaging system 300, some lenses may be configured so that an effective diameter Lx in the first direction intersecting the optical axis, and an effective diameter Ly in the second direction intersecting the optical axis, are different from each other. For example, as illustrated in FIG. 4, the lenses included in the second lens group LG2 in the optical imaging system 300 may be lenses having a D-cut shape in which a portion of a lens is cut away.

The optical imaging system 300 may further include a filter IF and an image plane IP. The image plane IP may be formed on an image sensor IS, and the filter IF may be disposed between the seventh lens 370 and the image plane IP.

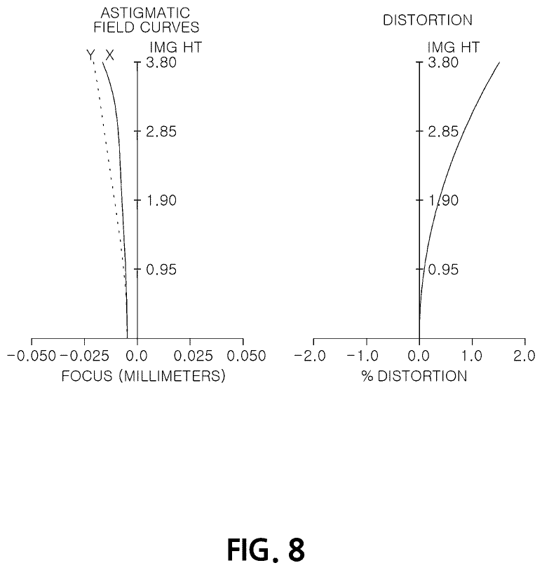

FIG. 8 is a graph illustrating aberration curves of the optical imaging system illustrated in FIG. 7.

Table 5 below lists characteristics of each of the lenses and other elements included in the optical imaging system 300 according to the third embodiment.

TABLE 5

| Surface | | Radius of | Thickness/ | Refractive | Abbe | Effective | Effective |
|---|---|---|---|---|---|---|---|
| No. | Element | Curvature | Distance | Index | Number | Radius X | Radius Y |
| S1 | First | 8.339 | 0.883 | 1.535 | 55.7 | 4.000 | 4.000 |
| S2 | Lens | 26.453 | 0.266 | | | 3.957 | 3.957 |
| S3 | Second | 392.027 | 0.400 | 1.614 | 25.9 | 3.958 | 3.958 |
| S4 | Lens | 21.096 | 0.181 | | | 3.827 | 3.827 |
| S5 | Third | 26.661 | 0.414 | 1.639 | 23.5 | 3.806 | 3.806 |
| S6 | Lens | 44.772 | 0.857 | | | 3.756 | 3.756 |
| S7 | Prism | Infinity | 2.800 | 1.717 | 29.5 | 4.000 | 2.800 |
| S8 | | Infinity | 2.800 | 1.717 | 29.5 | 4.000 | 4.383 |
| S9 | | Infinity | 2.272 | | | 4.000 | 2.800 |
| S10 | Fourth | 4.418 | 1.000 | 1.535 | 55.7 | 2.300 | 1.750 |
| S11 | Lens | −20.854 | 0.100 | | | 2.230 | 1.750 |
| | (Aperture) | | | | | | |
| S12 | Fifth | 156.163 | 1.139 | 1.614 | 25.9 | 2.142 | 1.750 |
| S13 | Lens | 2.893 | 0.800 | | | 1.705 | |
| S14 | Sixth | 6.432 | 1.200 | 1.661 | 20.4 | 1.916 | 1.750 |
| S15 | Lens | −10.568 | 0.482 | | | 1.967 | 1.750 |
| S16 | Seventh | −9.709 | 1.200 | 1.639 | 23.5 | 1.959 | 1.750 |
| S17 | Lens | 10.976 | 4.661 | | | 2.072 | 1.750 |
| S18 | Filter | Infinity | 0.210 | 1.517 | 64.2 | | |
| S19 | | Infinity | 2.145 | | | | |
| S20 | Image | Infinity | 0.005 | | | | |
| | Plane | | | | | | |

Table 6 below lists a conic constant k and aspherical surface coefficients A to H and J of each of the lenses included in the optical imaging system 300 according to the third embodiment.

TABLE 6

| Surface | | | | | | | |
|---|---|---|---|---|---|---|---|
| No. | S1 | S2 | S3 | S4 | S5 | S6 | S10 |
| k | −2.416E−01 | 1.694E+01 | −9.900E+01 | −3.478E+00 | −1.035E−01 | 3.600E−01 | 0.000E+00 |
| A | −2.353E−05 | −9.687E−05 | −1.773E−05 | −3.228E−05 | −5.160E−07 | 3.759E−07 | 3.177E−04 |
| B | −1.823E−06 | −4.091E−06 | −1.828E−07 | 1.887E−07 | −1.219E−07 | 1.226E−07 | −1.237E−04 |
| C | −9.276E−08 | −1.737E−07 | −1.946E−08 | 9.764E−08 | −3.066E−09 | 3.562E−09 | −1.448E−05 |
| D | 0 | 0 | 0 | 0 | −2.605E−10 | 5.292E−10 | −5.819E−07 |
| E | 0 | 0 | 0 | 0 | 0 | 0 | 0 |
| F | 0 | 0 | 0 | 0 | 0 | 0 | 0 |
| G | 0 | 0 | 0 | 0 | 0 | 0 | 0 |
| H | 0 | 0 | 0 | 0 | 0 | 0 | 0 |
| J | 0 | 0 | 0 | 0 | 0 | 0 | 0 |

| Surface | | | | | | | |
|---|---|---|---|---|---|---|---|
| No. | S11 | S12 | S13 | S14 | S15 | S16 | S17 |
| k | 3.707E−02 | 2.627E+01 | −1.244E+00 | 8.426E−02 | −1.132E+01 | 1.376E+01 | 0.000E+00 |
| A | 3.818E−01 | −3.084E−04 | −1.270E−01 | 4.256E−05 | 2.234E−01 | 6.974E−03 | −5.103E−04 |
| B | −1.017E+00 | 6.061E−05 | 5.468E−01 | 1.101E−05 | −3.728E−01 | −1.206E−03 | −2.423E−04 |
| C | 2.903E+00 | 9.107E−06 | −6.912E−01 | 1.850E−06 | −4.025E−02 | 3.292E−05 | −2.440E−07 |
| D | −1.150E+01 | −9.700E−07 | 2.687E+00 | −1.357E−08 | 6.598E−03 | 2.188E−05 | 1.102E−05 |
| E | 3.670E+01 | 0.000E+00 | −1.087E+01 | −9.121E−08 | 1.354E−01 | 0 | −9.350E−07 |
| F | −7.738E+01 | 0 | 3.092E+01 | −3.568E−08 | 7.211E−01 | 0 | 0 |
| G | 1.008E+02 | 0 | −5.628E+01 | −1.781E−18 | −1.722E+00 | 0 | 0 |
| H | −7.345E+01 | 0 | 5.797E+01 | −4.697E−20 | 1.253E+00 | 0 | 0 |
| J | 2.290E+01 | 0 | −2.562E+01 | 7.891E−24 | −2.489E−01 | 0 | 0 |

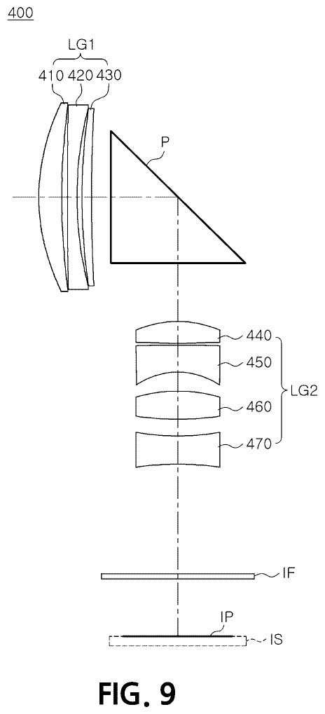

FIG. 9 is a configuration diagram illustrating an optical imaging system according to a fourth embodiment of the present disclosure.

Referring to FIG. 9, an optical imaging system 400 may include a plurality of lens groups. For example, the optical imaging system 400 may include a first lens group LG1 and a second lens group LG2 sequentially disposed in ascending numerical order along an optical axis of the optical imaging system 400 from an object side of the optical imaging system 400 toward an image plane of the optical imaging system 400. The first lens group LG1 and the second lens group LG2 may be formed of a plurality of lenses. As one example, the first lens group LG1 may be formed of a first lens 410, a second lens 420, and a third lens 430, and the second lens group LG2 each may be formed of a fourth lens 440, a fifth lens 450, a sixth lens 460, and a seventh lens 470. However, the lenses included in the first lens group LG1 and the second lens group LG2 are not limited to the above-described lenses.

The optical imaging system 400 may include an optical path folding element P. For example, the optical imaging system 400 may include an optical path folding element P in the form of a prism disposed between the first lens group LG1 and the second lens group LG2. In the optical imaging system 400 according to the present embodiment, the optical path folding element P may be configured so that lengths PIX and PEX in a first direction intersecting an optical axis, and lengths PIY and PEY in a second direction intersecting the optical axis, are different from each other as illustrated in FIGS. 3A and 3B. For example, an incident surface of the optical path folding element P may be formed so that a length PIX of the incident surface in the first direction intersecting the optical axis is greater than a length PIY of the incident surface in the second direction intersecting the optical axis, and an exit surface of the optical path folding element P may be formed so that a length PEX of the exit surface in the first direction intersecting the optical axis is greater than a length PEY of the exit surface in the second direction intersecting the optical axis.

Hereinafter, optical characteristics of the lenses included in the first lens group LG1 and the second lens group LG2 will be described.

The first lens 410 may have a positive refractive power, and may have an object-side surface having a convex shape in a paraxial region thereof, and an image-side surface having a concave shape in a paraxial region thereof. The second lens 420 may have a negative refractive power, and may have an object-side surface having a convex shape in a paraxial region thereof, and an image-side surface having a concave shape in a paraxial region thereof. The third lens 430 may have a positive refractive power, and may have an object-side surface having a convex shape in a paraxial region thereof, and an image-side surface having a concave shape in a paraxial region thereof. The fourth lens 440 may have a positive refractive power, and may have an object-side surface having a convex shape in a paraxial region thereof, and an image-side surface having a convex shape in a paraxial region thereof. The fifth lens 450 may have a negative refractive power, and may have an object-side surface having a convex shape in a paraxial region thereof, and an image-side surface having a concave shape in a paraxial region thereof. The sixth lens 460 may have a positive refractive power, and may have an object-side surface having a convex shape in a paraxial region thereof, and an image-side surface having a convex shape in a paraxial region thereof. The seventh lens 470 may have a negative refractive power, and may have an object-side surface having a concave shape in a paraxial region thereof, and an image-side surface having a concave shape in a paraxial region thereof.

In the optical imaging system 400, some lenses may be configured so that an effective diameter Lx in the first direction intersecting the optical axis, and an effective diameter Ly in the second direction intersecting the optical axis, are different from each other. For example, as illustrated in FIG. 4, the lenses included in the second lens group LG2 in the optical imaging system 400 may be lenses having a D-cut shape in which a portion of a lens is cut away.

The optical imaging system 400 may further include a filter IF and an image plane IP. The image plane IP may be formed on an image sensor IS, and the filter IF may be disposed between the seventh lens 470 and the image plane IP.

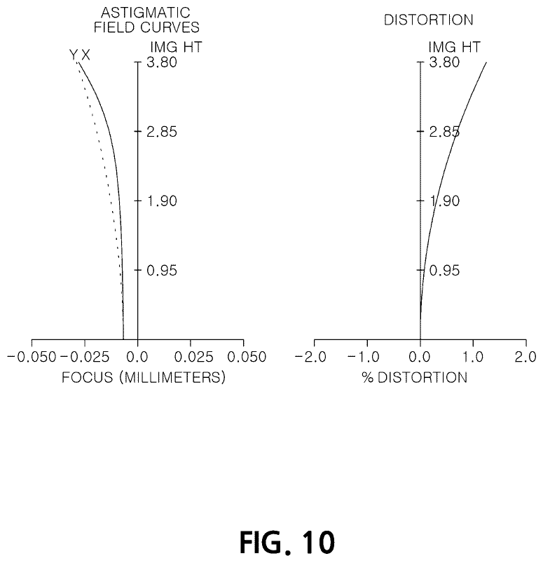

FIG. 10 is a graph illustrating aberration curves of the optical imaging system illustrated in FIG. 9.

Table 7 below lists characteristics of each of the lenses and other elements included in the optical imaging system 400 according to the fourth embodiment.

TABLE 7

| Surface | | Radius of | Thickness/ | Refractive | Abbe | Effective | Effective |
|---|---|---|---|---|---|---|---|
| No. | Element | Curvature | Distance | Index | Number | Radius X | Radius Y |
| S1 | First | 8.679 | 0.953 | 1.535 | 55.7 | 4.000 | 4.000 |
| S2 | Lens | 27.970 | 0.235 | | | 3.935 | 3.935 |
| S3 | Second | 161.109 | 0.400 | 1.614 | 25.9 | 3.929 | 3.929 |
| S4 | Lens | 14.998 | 0.215 | | | 3.768 | 3.768 |
| S5 | Third | 25.887 | 0.400 | 1.639 | 23.5 | 3.765 | 3.765 |
| S6 | Lens | 83.122 | 0.800 | | | 3.733 | 3.733 |
| S7 | Prism | Infinity | 2.800 | 1.717 | 29.5 | 4.000 | 2.800 |
| S8 | | Infinity | 2.800 | 1.717 | 29.5 | 4.000 | 4.383 |
| S9 | | Infinity | 2.500 | | | 4.000 | 2.800 |
| S10 | Fourth | 4.403 | 0.916 | 1.535 | 55.7 | 2.300 | 1.750 |
| S11 | Lens | −21.335 | 0.100 | | | 2.250 | 1.750 |
| | (Aperture) | | | | | | |
| S12 | Fifth | 149.978 | 1.134 | 1.614 | 25.9 | 2.162 | 1.750 |
| S13 | Lens | 2.837 | 0.800 | | | 1.732 | |
| S14 | Sixth | 6.121 | 1.200 | 1.661 | 20.4 | 1.952 | 1.750 |
| S15 | Lens | −10.389 | 0.707 | | | 1.992 | 1.750 |
| S16 | Seventh | −9.670 | 1.200 | 1.650 | 21.5 | 1.971 | 1.750 |
| S17 | Lens | 11.843 | 4.661 | | | 2.073 | 1.750 |
| S18 | Filter | Infinity | 0.210 | 1.517 | 64.2 | | |
| S19 | | Infinity | 2.442 | | | | |
| S20 | Image | Infinity | 0.007 | | | | |
| | Plane | | | | | | |

Table 8 below lists a conic constant k and aspherical surface coefficients A to H and J of each of the lenses included in the optical imaging system 400 according to the fourth embodiment.

TABLE 8

| Surface | | | | | | | |
|---|---|---|---|---|---|---|---|
| No. | S1 | S2 | S3 | S4 | S5 | S6 | S10 |
| k | −3.422E−01 | 1.694E+01 | 8.344E+01 | −2.497E+00 | −5.368E−01 | 2.802E+01 | 0.000E+00 |
| A | −5.136E−05 | −9.971E−05 | −2.772E−05 | −1.686E−05 | −4.381E−06 | 5.816E−06 | 3.217E−04 |
| B | −2.038E−06 | −5.240E−06 | −7.145E−07 | 9.284E−07 | −3.581E−07 | 5.635E−07 | −1.254E−04 |
| C | −8.968E−08 | −2.301E−07 | −6.365E−08 | 1.259E−07 | 1.630E−08 | −1.107E−08 | −1.413E−05 |
| D | 0 | 0 | 0 | 0 | −1.283E−09 | 1.551E−09 | −4.956E−07 |
| E | 0 | 0 | 0 | 0 | 0 | 0 | 0 |
| F | 0 | 0 | 0 | 0 | 0 | 0 | 0 |
| G | 0 | 0 | 0 | 0 | 0 | 0 | 0 |
| H | 0 | 0 | 0 | 0 | 0 | 0 | 0 |
| J | 0 | 0 | 0 | 0 | 0 | 0 | 0 |

| Surface | | | | | | | |
|---|---|---|---|---|---|---|---|
| No. | S11 | S12 | S13 | S14 | S15 | S16 | S17 |
| k | 3.707E−02 | 3.843E+01 | −1.273E+00 | 2.309E−01 | −9.415E+00 | 1.431E+01 | 0.000E+00 |
| A | 5.967E−03 | −3.190E−04 | −3.352E−03 | 1.437E−04 | 3.764E−03 | 6.428E−03 | 2.397E−04 |
| B | −1.637E−03 | 5.177E−05 | 1.097E−03 | 2.149E−05 | −8.437E−04 | −1.159E−03 | −4.099E−04 |
| C | 2.975E−04 | 5.814E−06 | 2.146E−03 | 1.681E−06 | −6.301E−05 | 4.519E−05 | 1.295E−05 |
| D | −8.527E−05 | −1.836E−06 | −2.568E−03 | −2.327E−07 | 3.826E−06 | 2.402E−05 | 1.360E−05 |
| E | 3.242E−05 | 0 | 1.761E−03 | −5.045E−08 | 1.384E−05 | 0 | −1.256E−06 |
| F | −9.345E−06 | 0 | −7.587E−04 | −2.684E−09 | −7.150E−06 | 0 | 0 |
| G | 1.657E−06 | 0 | 2.000E−04 | 2.277E−09 | 1.951E−06 | 0 | 0 |
| H | −1.609E−07 | 0 | −2.949E−05 | 1.840E−19 | −2.713E−07 | 0 | 0 |
| J | 6.547E−09 | 0 | 1.859E−06 | −8.663E−21 | 1.497E−08 | 0 | 0 |

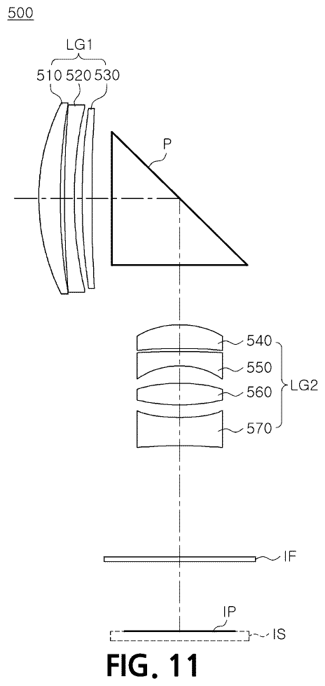

FIG. 11 is a configuration diagram illustrating an optical imaging system according to a fifth embodiment of the present disclosure.

Referring to FIG. 11, an optical imaging system 500 may include a plurality of lens groups. For example, the optical imaging system 500 may include a first lens group LG1 and a second lens group LG2 sequentially disposed in ascending numerical order along an optical axis of the optical imaging system 500 from an object side of the optical imaging system 500 toward an image plane of the optical imaging system 500. The first lens group LG1 and the second lens group LG2 each may be formed of a plurality of lenses. As one example, the first lens group LG1 may be formed of a first lens 510, a second lens 520, and a third lens 530, and the second lens group LG2 may be formed of a fourth lens 540, a fifth lens 550, a sixth lens 560, and a seventh lens 570. However, the lenses included in the first lens group LG1 and the second lens group LG2 are not limited to the above-described lenses.

The optical imaging system 500 may include an optical path folding element P. For example, the optical imaging system 500 may include an optical path folding element P in the form of a prism disposed between the first lens group LG1 and the second lens group LG2. In the optical imaging system 500 according to the present embodiment, the optical path folding element P may be configured so that lengths PIX and PEX in a first direction intersecting an optical axis, and lengths PIY and PEY in a second direction intersecting the optical axis, are different from each other as illustrated in FIGS. 3A and 3B. For example, an incident surface of the optical path folding element P may be formed so that a length PIX of the incident surface in the first direction intersecting the optical axis is greater than a length PIY of the incident surface in the second direction intersecting the optical axis, and an exit surface of the optical path folding element P may be formed so that a length PEX of the exit surface in the first direction intersecting the optical axis is greater than a length PEY of the exit surface in the second direction intersecting the optical axis.

Hereinafter, optical characteristics of the lenses included in the first lens group LG1 and the second lens group LG2 will be described.

The first lens 510 may have a positive refractive power, and may have an object-side surface having a convex shape in a paraxial region thereof, and an image-side surface having a concave shape in a paraxial region thereof. The second lens 520 may have a negative refractive power, and may have an object-side surface having a convex shape in a paraxial region thereof, and an image-side surface having a concave shape in a paraxial region thereof. The third lens 530 may have a positive refractive power, and may have an object-side surface having a convex shape in a paraxial region thereof, and an image-side surface having a concave shape in a paraxial region thereof. The fourth lens 540 may have a positive refractive power, and may have an object-side surface having a convex shape in a paraxial region thereof, and an image-side surface having a concave shape in a paraxial region thereof. The fifth lens 550 may have a negative refractive power, and may have an object-side surface having a convex shape in a paraxial region thereof, and an image-side surface having a concave shape in a paraxial region thereof. The sixth lens 560 may have a positive refractive power, and may have an object-side surface having a convex shape in a paraxial region thereof, and an image-side surface having a convex shape in a paraxial region thereof. The seventh lens 570 may have a negative refractive power, and may have an object-side surface having a concave shape in a paraxial region thereof, and an image-side surface having a concave shape in a paraxial region thereof.

In the optical imaging system 500, some lenses may be configured so that an effective diameter Lx in the first direction intersecting the optical axis, and an effective diameter Ly in the second direction intersecting the optical axis, are different from each other. For example, as illustrated in FIG. 4, the lenses included in the second lens group LG2 in the optical imaging system 500 may be lenses having a D-cut shape in which a portion of a lens is cut away.

The optical imaging system 500 may further include a filter IF and an image plane IP. The image plane IP may be formed on an image sensor IS, and the filter IF may be disposed between the seventh lens 570 and the image plane IP.

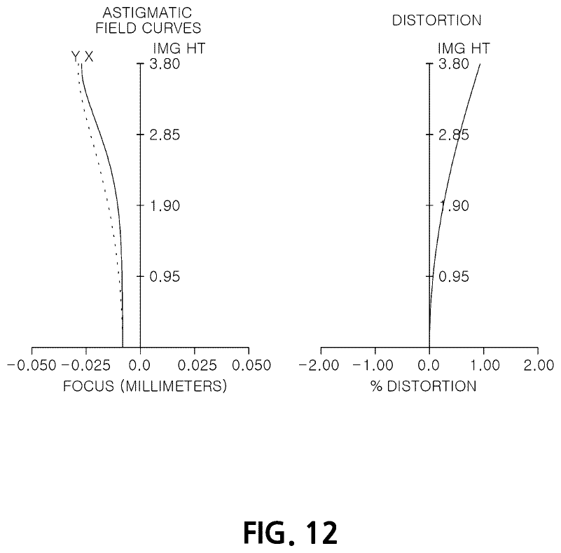

FIG. 12 is a graph illustrating aberration curves of the optical imaging system illustrated in FIG. 11.

Table 9 below lists characteristics of each of the lenses and other elements included in the optical imaging system 500 according to the fifth embodiment.

TABLE 9

| Surface | | Radius of | Thickness/ | Refractive | Abbe | Effective | Effective |
|---|---|---|---|---|---|---|---|
| No. | Element | Curvature | Distance | Index | Number | Radius X | Radius Y |
| S1 | First | 9.072 | 0.883 | 1.535 | 55.7 | 4.000 | 4.000 |
| S2 | Lens | 25.359 | 0.180 | | | 3.936 | 3.936 |
| S3 | Second | 49.013 | 0.400 | 1.614 | 25.9 | 3.930 | 3.930 |
| S4 | Lens | 17.516 | 0.322 | | | 3.797 | 3.797 |
| S5 | Third | 26.610 | 0.400 | 1.535 | 55.7 | 3.769 | 3.769 |
| S6 | Lens | 66.627 | 0.815 | | | 3.731 | 3.731 |
| S7 | Prism | Infinity | 2.800 | 1.717 | 29.5 | 4.000 | 2.800 |
| S8 | | Infinity | 2.800 | 1.717 | 29.5 | 4.000 | 4.383 |
| S9 | | Infinity | 2.500 | | | 4.000 | 2.800 |
| S10 | Fourth | 3.549 | 0.997 | 1.535 | 55.7 | 2.300 | 1.750 |
| S11 | Lens | 26.287 | 0.131 | | | 2.219 | 1.750 |
| | (Aperture) | | | | | | |
| S12 | Fifth | 33.159 | 0.596 | 1.614 | 25.9 | 2.191 | 1.750 |
| S13 | Lens | 2.876 | 0.732 | | | 1.876 | 1.750 |
| S14 | Sixth | 6.687 | 0.901 | 1.650 | 21.5 | 2.038 | 1.750 |
| S15 | Lens | −7.934 | 0.526 | | | 2.032 | 1.750 |
| S16 | Seventh | −8.621 | 1.178 | 1.639 | 23.5 | 1.938 | 1.750 |
| S17 | Lens | 10.705 | 4.661 | | | 2.117 | 1.750 |
| S18 | Filter | Infinity | 0.210 | 1.517 | 64.2 | | |
| S19 | | Infinity | 2.908 | | | | |
| S20 | Image | Infinity | 0.008 | | | | |
| | Plane | | | | | | |

Table 5 below lists a conic constant k and aspherical surface coefficients A to H and J of each of the lenses included in the optical imaging system 500 according to the fifth embodiment.

TABLE 10

| Surface | | | | | | | |
|---|---|---|---|---|---|---|---|
| No. | S1 | S2 | S3 | S4 | S5 | S6 | S10 |
| k | −2.594E−01 | 1.332E+01 | −7.064E+01 | −3.419E+00 | 7.655E−02 | −9.520E−01 | 0.000E+00 |
| A | −3.633E−05 | −5.906E−05 | 3.158E−05 | −2.276E−05 | 2.113E−06 | −2.842E−06 | 9.134E−04 |
| B | 2.468E−06 | −1.316E−06 | −1.031E−07 | 6.124E−06 | −9.776E−08 | 1.100E−07 | −1.122E−04 |
| C | 1.093E−07 | −7.534E−08 | 6.381E−08 | 2.293E−07 | 6.222E−10 | −1.074E−08 | −7.553E−06 |
| D | 0 | 0 | 0 | 0 | −4.854E−11 | 2.890E−10 | 1.312E−06 |
| E | 0 | 0 | 0 | 0 | 0 | 0 | 0 |
| F | 0 | 0 | 0 | 0 | 0 | 0 | 0 |
| G | 0 | 0 | 0 | 0 | 0 | 0 | 0 |
| H | 0 | 0 | 0 | 0 | 0 | 0 | 0 |
| J | 0 | 0 | 0 | 0 | 0 | 0 | 0 |

| Surface | | | | | | | |
|---|---|---|---|---|---|---|---|
| No. | S11 | S12 | S13 | S14 | S15 | S16 | S17 |
| k | 3.707E−02 | −3.234E+01 | −1.306E+00 | 1.460E+00 | −3.032E−02 | 6.167E−01 | 1.502E+01 |
| A | 9.890E−03 | −4.450E−04 | −8.229E−03 | −2.507E−03 | 1.168E−05 | −9.454E−03 | −9.667E−03 |
| B | −4.490E−03 | 8.643E−08 | 5.398E−03 | 1.285E−03 | −9.909E−06 | −2.638E−04 | 4.071E−04 |
| C | 1.528E−03 | −6.297E−06 | 1.269E−04 | −1.831E−05 | −1.374E−06 | 2.212E−05 | −1.065E−05 |
| D | −6.312E−04 | −4.622E−06 | −1.432E−03 | 7.179E−06 | −2.847E−07 | −1.377E−05 | −3.154E−06 |
| E | 2.401E−04 | 0 | 1.198E−03 | −6.768E−06 | 0 | −8.110E−07 | 0 |
| F | −6.485E−05 | 0 | −5.593E−04 | 1.395E−06 | 0 | 2.552E−07 | 0 |
| G | 1.106E−05 | 0 | 1.530E−04 | 2.602E−07 | 0 | 1.978E−18 | 0 |
| H | −1.069E−06 | 0 | −2.284E−05 | −1.320E−07 | 0 | 4.829E−20 | 0 |
| J | 4.453E−08 | 0 | 1.434E−06 | 1.323E−08 | 0 | −8.435E−23 | 0 |

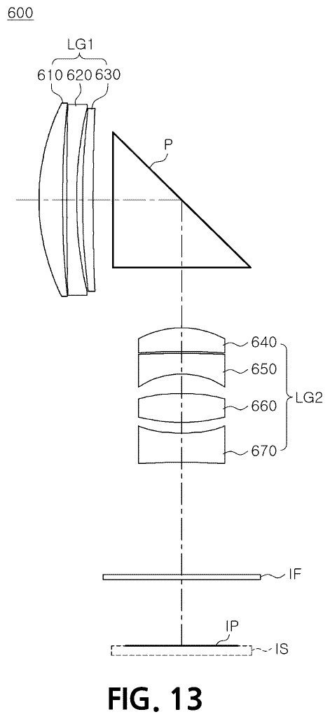

FIG. 13 is a configuration diagram illustrating an optical imaging system according to a sixth embodiment of the present disclosure.

Referring to FIG. 13, an optical imaging system 600 may include a plurality of lens groups. For example, the optical imaging system 600 may include a first lens group LG1 and a second lens group LG2 sequentially disposed in ascending numerical order along an optical axis of the optical imaging system 600 from an object side of the optical imaging system 600 toward an image plane of the optical imaging system 600. The first lens group LG1 and the second lens group LG2 each may be formed of a plurality of lenses. As one example, the first lens group LG1 may be formed of a first lens 610, a second lens 620, and a third lens 630, and the second lens group LG2 may be formed of a fourth lens 640, a fifth lens 650, a sixth lens 660, and a seventh lens 670. However, the lenses included in the first lens group LG1 and the second lens group LG2 are not limited to the above-described lenses.

The optical imaging system 600 may include an optical path folding element P. For example, the optical imaging system 600 may include an optical path folding element P in the form of a prism disposed between the first lens group LG1 and the second lens group LG2. In the optical imaging system 600 according to the present embodiment, the optical path folding element P may be configured so that lengths PIX and PEX in a first direction intersecting an optical axis, and lengths PIY and PEY in a second direction intersecting the optical axis, are different from each other as illustrated in FIGS. 3A and 3B. For example, an incident surface of the optical path folding element P may be formed so that a length PIX of the incident surface in the first direction intersecting the optical axis is greater than a length PIY of the incident surface in the second direction intersecting the optical axis, and an exit surface of the optical path folding element P may be formed so that a length PEX of the exit surface in the first direction intersecting the optical axis is greater than a length PEY of the exit surface in the second direction intersecting the optical axis.

Hereinafter, optical characteristics of the lenses included in the first lens group LG1 and the second lens group LG2 will be described.

The first lens 610 may have a positive refractive power, and may have an object-side surface having a convex shape in a paraxial region thereof, and an image-side surface having a concave shape in a paraxial region thereof. The second lens 620 may have a negative refractive power, and may have an object-side surface having a convex shape in a paraxial region thereof, and an image-side surface having a concave shape in a paraxial region thereof. The third lens 630 may have a positive refractive power, and may have an object-side surface having a convex shape in a paraxial region thereof, and an image-side surface having a concave shape in a paraxial region thereof. The fourth lens 640 may have a positive refractive power, and may have an object-side surface having a convex shape in a paraxial region thereof, and an image-side surface having a concave shape in a paraxial region thereof. The fifth lens 650 may have a negative refractive power, and may have an object-side surface having a convex shape in a paraxial region thereof, and an image-side surface having a concave shape in a paraxial region thereof. The sixth lens 660 may have a positive refractive power, and may have an object-side surface having a convex shape in a paraxial region thereof, and an image-side surface having a convex shape in a paraxial region thereof. The seventh lens 670 may have a negative refractive power, and may have an object-side surface having a concave shape in a paraxial region thereof, and an image-side surface having a concave shape in a paraxial region thereof.

In the optical imaging system 600, some lenses may be configured so that an effective diameter Lx in the first direction intersecting the optical axis, and an effective diameter Ly in the second direction intersecting the optical axis, are different from each other. For example, as illustrated in FIG. 4, the lenses included in the second lens group LG2 in the optical imaging system 600 may be lenses having a D-cut shape in which a portion of a lens is cut away.

The optical imaging system 600 may further include a filter IF and an image plane IP. The image plane IP may be formed on an image sensor IS, and the filter IF may be disposed between the seventh lens 670 and the image plane IP.

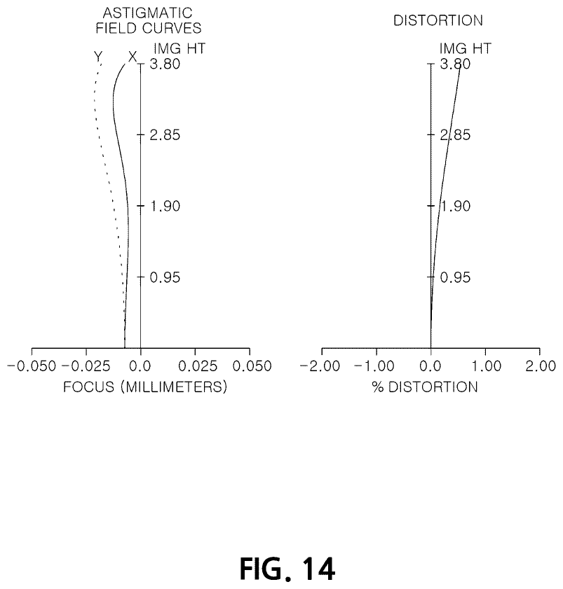

FIG. 14 is a graph illustrating aberration curves of the optical imaging system illustrated in FIG. 13.

Table 11 below lists characteristics of each of the lenses and other elements included in the optical imaging system 600 according to the sixth embodiment.

TABLE 11

| Surface | | Radius of | Thickness/ | Refractive | Abbe | Effective | Effective |
|---|---|---|---|---|---|---|---|
| No. | Element | Curvature | Distance | Index | Number | Radius X | Radius Y |
| S1 | First | 8.991 | 0.958 | 1.535 | 55.7 | 4.000 | 4.000 |
| S2 | Lens | 39.617 | 0.171 | | | 3.946 | 3.946 |
| S3 | Second | 338.695 | 0.400 | 1.614 | 25.9 | 3.943 | 3.943 |
| S4 | Lens | 17.398 | 0.246 | | | 3.788 | 3.788 |
| S5 | Third | 32.500 | 0.425 | 1.650 | 21.5 | 3.781 | 3.781 |
| S6 | Lens | 95.183 | 0.800 | | | 3.741 | 3.741 |
| S7 | Prism | Infinity | 2.800 | 1.717 | 29.5 | 4.000 | 2.800 |
| S8 | | Infinity | 2.800 | 1.717 | 29.5 | 4.000 | 4.383 |
| S9 | | Infinity | 2.500 | | | 4.000 | 2.800 |
| S10 | Fourth | 3.626 | 0.986 | 1.535 | 55.7 | 2.300 | 1.750 |
| S11 | Lens | 72.274 | 0.104 | | | 2.237 | 1.750 |
| | (Aperture) | | | | | | |
| S12 | Fifth | 75.268 | 0.827 | 1.614 | 25.9 | 2.212 | 1.750 |
| S13 | Lens | 2.875 | 0.800 | | | 1.876 | 1.750 |
| S14 | Sixth | 7.261 | 1.200 | 1.650 | 21.5 | 2.058 | 1.750 |
| S15 | Lens | −7.295 | 0.436 | | | 2.052 | 1.750 |
| S16 | Seventh | −8.455 | 1.200 | 1.639 | 23.5 | 1.979 | 1.750 |
| S17 | Lens | 12.202 | 4.661 | | | 2.189 | 1.750 |
| S18 | Filter | Infinity | 0.210 | 1.517 | 64.2 | | |
| S19 | | Infinity | 2.731 | | | | |
| S20 | Image | Infinity | 0.007 | | | | |
| | Plane | | | | | | |

Table 12 below lists a conic constant k and aspherical surface coefficients A to H and J of each of the lenses included in the optical imaging system 600 according to the sixth embodiment.

TABLE 12

| Surface | | | | | | | |
|---|---|---|---|---|---|---|---|
| No. | S1 | S2 | S3 | S4 | S5 | S6 | S10 |
| k | −3.482E−01 | 1.736E+01 | −9.900E+01 | −2.541E+00 | −5.006E−01 | 6.851E+00 | 0.000E+00 |
| A | −5.401E−05 | −4.820E−05 | 2.327E−05 | −1.195E−05 | −1.514E−06 | 1.408E−06 | 7.136E−04 |
| B | 1.761E−06 | −2.724E−07 | 2.107E−07 | 5.165E−06 | −1.139E−08 | 3.408E−08 | −1.663E−04 |
| C | 1.024E−07 | 1.757E−08 | 4.824E−08 | 1.473E−07 | 1.322E−09 | −1.999E−09 | −1.385E−05 |
| D | 0 | 0 | 0 | 0 | −2.154E−11 | −1.106E−10 | 5.762E−07 |
| E | 0 | 0 | 0 | 0 | 0 | 0 | 0 |
| F | 0 | 0 | 0 | 0 | 0 | 0 | 0 |
| G | 0 | 0 | 0 | 0 | 0 | 0 | 0 |
| H | 0 | 0 | 0 | 0 | 0 | 0 | 0 |
| J | 0 | 0 | 0 | 0 | 0 | 0 | 0 |

| Surface | | | | | | | |
|---|---|---|---|---|---|---|---|
| No. | S11 | S12 | S13 | S14 | S15 | S16 | S17 |
| k | 3.707E−02 | 7.066E+01 | −1.359E+00 | 1.619E+00 | −1.298E−02 | 7.277E−01 | 1.745E+01 |
| A | 6.006E−01 | −3.968E−04 | −3.516E−01 | −1.319E−01 | 5.430E−06 | −9.450E−03 | −9.450E−03 |
| B | −2.146E+00 | 1.765E−05 | 1.627E+00 | 5.515E−01 | −2.341E−06 | −3.187E−04 | 3.967E−04 |
| C | 6.308E+00 | −2.553E−06 | −1.466E+00 | −2.249E−01 | −3.657E−07 | 1.620E−05 | −1.161E−05 |
| D | −2.157E+01 | −4.009E−06 | −7.893E+00 | −2.798E−01 | −1.597E−07 | −1.248E−05 | −1.184E−06 |
| E | 6.131E+01 | 0 | 6.153E+01 | 4.435E+00 | 0 | −3.377E−07 | 0 |
| F | −1.191E+02 | 0 | −2.096E+02 | −1.744E+01 | 0 | 1.700E−07 | 0 |
| G | 1.450E+02 | 0 | 3.891E+02 | 3.400E+01 | 0 | −4.888E−17 | 0 |
| H | −9.979E+01 | 0 | −3.811E+02 | −3.406E+01 | 0 | −2.500E−18 | 0 |
| J | 2.967E+01 | 0 | 1.541E+02 | 1.400E+01 | 0 | −1.295E−19 | 0 |

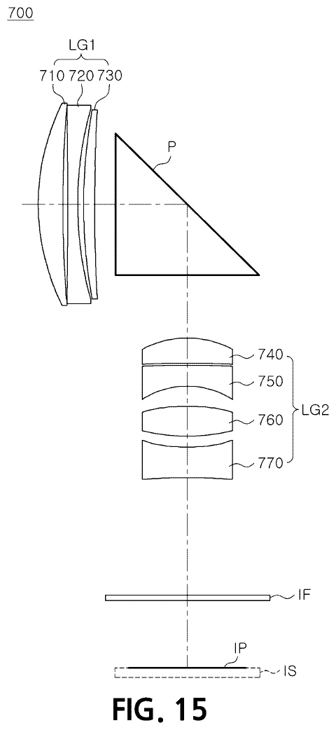

FIG. 15 is a configuration diagram illustrating an optical imaging system according to a seventh embodiment of the present disclosure.

Referring to FIG. 15, an optical imaging system 700 may include a plurality of lens groups. For example, the optical imaging system 700 may include a first lens group LG1 and a second lens group LG2 sequentially disposed in ascending numerical order along an optical axis of the optical imaging system 700 from an object side of the optical imaging system 700 toward an image plane of the optical imaging system 700. The first lens group LG1 and the second lens group LG2 may be formed of a plurality of lenses. As one example, the first lens group LG1 may be formed of a first lens 710, a second lens 720, and a third lens 730, and the second lens group LG2 each may be formed of a fourth lens 740, a fifth lens 750, a sixth lens 760, and a seventh lens 770. However, the lenses included in the first lens group LG1 and the second lens group LG2 are not limited to the above-described lenses.

The optical imaging system 700 may include an optical path folding element P. For example, the optical imaging system 700 may include an optical path folding element P in the form of a prism disposed between the first lens group LG1 and the second lens group LG2. In the optical imaging system 700 according to the present embodiment, the optical path folding element P may be configured so that lengths PIX and PEX in a first direction intersecting an optical axis, and lengths PIY and PEY in a second direction intersecting the optical axis, are different from each other as illustrated in FIGS. 3A and 3B. For example, an incident surface of the optical path folding element P may be formed so that a length PIX of the incident surface in the first direction intersecting the optical axis is greater than a length PIY of the incident surface in the second direction intersecting the optical axis, and an exit surface of the optical path folding element P may be formed so that a length PEX of the exit surface in the first direction intersecting the optical axis is greater than a length PEY of the exit surface in the second direction intersecting the optical axis.

Hereinafter, optical characteristics of the lenses included in the first lens group LG1 and the second lens group LG2 will be described.

The first lens 710 may have a positive refractive power, and may have an object-side surface having a convex shape in a paraxial region thereof, and an image-side surface having a concave shape in a paraxial region thereof. The second lens 720 may have a negative refractive power, and may have an object-side surface having a concave shape in a paraxial region thereof, and an image-side surface having a concave shape in a paraxial region thereof. The third lens 730 may have a positive refractive power, and may have an object-side surface having a convex shape in a paraxial region thereof, and an image-side surface having a concave shape in a paraxial region thereof. The fourth lens 740 may have a positive refractive power, and may have an object-side surface having a convex shape in a paraxial region thereof, and an image-side surface having a concave shape in a paraxial region thereof. The fifth lens 750 may have a negative refractive power, and may have an object-side surface having a convex shape in a paraxial region thereof, and an image-side surface having a concave shape in a paraxial region thereof. The sixth lens 760 may have a positive refractive power, and may have an object-side surface having a convex shape in a paraxial region thereof, and an image-side surface having a convex shape in a paraxial region thereof. The seventh lens 770 may have a negative refractive power, and may have an object-side surface having a concave shape in a paraxial region thereof, and an image-side surface having a concave shape in a paraxial region thereof.

In the optical imaging system 700, some lenses may be configured so that an effective diameter Lx in the first direction intersecting the optical axis, and an effective diameter Ly in the second direction intersecting the optical axis, are different from each other. For example, as illustrated in FIG. 4, the lenses included in the second lens group LG2 in the optical imaging system 700 may be lenses having a D-cut shape in which a portion of a lens is cut away.

The optical imaging system 700 may further include a filter IF and an image plane IP. The image plane IP may be formed on an image sensor IS, and the filter IF may be disposed between the seventh lens 770 and the image plane IP.

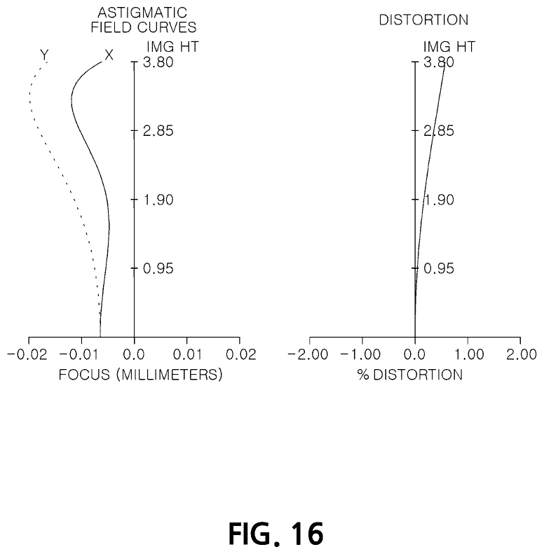

FIG. 16 is a graph illustrating aberration curves of the optical imaging system illustrated in FIG. 15.

Table 13 below lists characteristics of each of the lenses and other elements included in the optical imaging system 700 according to the seventh embodiment.

TABLE 13

| Surface | | Radius of | Thickness/ | Refractive | Abbe | Effective | Effective |
|---|---|---|---|---|---|---|---|
| No. | Element | Curvature | Distance | Index | Number | Radius X | Radius Y |
| S1 | First | 8.906 | 0.957 | 1.535 | 55.7 | 4.000 | 4.000 |
| S2 | Lens | 48.127 | 0.181 | | | 3.956 | 3.956 |
| S3 | Second | −265.460 | 0.400 | 1.535 | 55.7 | 3.956 | 3.956 |
| S4 | Lens | 14.268 | 0.228 | | | 3.777 | 3.777 |
| S5 | Third | 21.603 | 0.434 | 1.650 | 21.5 | 3.771 | 3.771 |
| S6 | Lens | 75.771 | 0.800 | | | 3.742 | 3.742 |
| S7 | Prism | Infinity | 2.800 | 1.717 | 29.5 | 4.000 | 2.800 |
| S8 | | Infinity | 2.800 | 1.717 | 29.5 | 4.000 | 4.383 |
| S9 | | Infinity | 2.500 | | | 4.000 | 2.800 |
| S10 | Fourth | 3.656 | 0.990 | 1.544 | 56.0 | 2.300 | 1.750 |
| S11 | Lens | 69.416 | 0.107 | | | 2.233 | 1.750 |
| | (Aperture) | | | | | | |
| S12 | Fifth | 65.226 | 0.802 | 1.614 | 25.9 | 2.206 | 1.750 |
| S13 | Lens | 2.881 | 0.798 | | | 1.876 | 1.750 |
| S14 | Sixth | 7.186 | 1.189 | 1.650 | 21.5 | 2.057 | 1.750 |
| S15 | Lens | −7.425 | 0.436 | | | 2.049 | 1.750 |
| S16 | Seventh | −8.545 | 1.200 | 1.639 | 23.5 | 1.977 | 1.750 |
| S17 | Lens | 11.770 | 4.661 | | | 2.183 | 1.750 |
| S18 | Filter | Infinity | 0.210 | 1.517 | 64.2 | | |
| S19 | | Infinity | 2.659 | | | | |
| S20 | Image | Infinity | 0.006 | | | | |
| | Plane | | | | | | |

Table 14 below lists a conic constant k and aspherical surface coefficients A to H and J of each of the lenses included in the optical imaging system 700 according to the seventh embodiment.

TABLE 14

| Surface | | | | | | | |
|---|---|---|---|---|---|---|---|
| No. | S1 | S2 | S3 | S4 | S5 | S6 | S10 |
| k | −0.3821 | 19.31 | 99 | −2.223 | −0.1401 | 2.831 | 0 |
| A | −6.152E−05 | −4.303E−05 | 0.0000168 | −3.401E−06 | −1.411E−06 | 9.724E−07 | 0.0006926 |
| B | 1.701E−06 | −2.855E−07 | 2.134E−07 | 5.128E−06 | −5.367E−08 | 8.724E−08 | −0.0001671 |
| C | 9.653E−08 | 2.527E−08 | 4.335E−08 | 1.411E−07 | 8.374E−10 | 2.356E−10 | −1.343E−05 |
| D | 0 | 0 | 0 | 0 | 4.864E−11 | 5.161E−11 | 6.393E−07 |
| E | 0 | 0 | 0 | 0 | 0 | 0 | 0 |
| F | 0 | 0 | 0 | 0 | 0 | 0 | 0 |
| G | 0 | 0 | 0 | 0 | 0 | 0 | 0 |
| H | 0 | 0 | 0 | 0 | 0 | 0 | 0 |
| J | 0 | 0 | 0 | 0 | 0 | 0 | 0 |

| Surface | | | | | | | |
|---|---|---|---|---|---|---|---|
| No. | S11 | S12 | S13 | S14 | S15 | S16 | S17 |
| k | 0.03707 | 53.35 | −1.37 | 1.56 | −0.01464 | 0.6556 | 16.5 |
| A | 0.1842 | −0.000407 | −0.08129 | −0.03346 | 5.878E−06 | −0.009442 | −0.009447 |
| B | −0.3635 | 0.00001661 | 0.1819 | 0.07051 | −3.204E−06 | −0.000286 | 0.0004003 |
| C | 0.576 | −2.749E−06 | −0.09823 | −0.008227 | −2.686E−07 | 0.00001953 | −8.886E−06 |
| D | −1.056 | −4.055E−06 | −0.1238 | −0.03962 | −5.707E−08 | −1.201E−05 | −2.007E−06 |
| E | 1.629 | 0 | 0.5696 | 0.1437 | 0 | −3.665E−07 | 0 |
| F | −1.732 | 0 | −0.9649 | −0.2396 | 0 | 1.17E−07 | 0 |
| G | 1.156 | 0 | 0.8685 | 0.2173 | 0 | −5.029E−17 | 0 |
| H | −0.437 | 0 | −0.4093 | −0.1043 | 0 | −2.52E−18 | 0 |
| J | 0.07137 | 0 | 0.07941 | 0.0208 | 0 | −1.293E−19 | 0 |

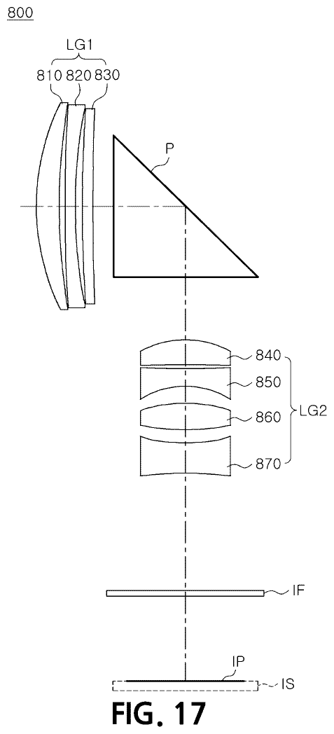

FIG. 17 is a configuration diagram illustrating an optical imaging system according to an eighth embodiment of the present disclosure.

Referring to FIG. 17, an optical imaging system 800 may include a plurality of lens groups. For example, the optical imaging system 800 may include a first lens group LG1 and a second lens group LG2 sequentially disposed in ascending numerical order along an optical axis of the optical imaging system 800 from an object side of the optical imaging system 800 toward an image plane of the optical imaging system 800. The first lens group LG1 and the second lens group LG2 each may be formed of a plurality of lenses. As one example, the first lens group LG1 may be formed of a first lens 810, a second lens 820, and a third lens 830, and the second lens group LG2 may be formed of a fourth lens 840, a fifth lens 850, a sixth lens 860, and a seventh lens 870. However, the lenses included in the first lens group LG1 and the second lens group LG2 are not limited to the above-described lenses.

The optical imaging system 800 may include an optical path folding element P. For example, the optical imaging system 800 may include an optical path folding element P in the form of a prism disposed between the first lens group LG1 and the second lens group LG2. In the optical imaging system 800 according to the present embodiment, the optical path folding element P may be configured so that lengths PIX and PEX in a first direction intersecting an optical axis, and lengths PIY and PEY in a second direction intersecting the optical axis, are different from each other as illustrated in FIGS. 3A and 3B. For example, an incident surface of the optical path folding element P may be formed so that a length PIX of the incident surface in the first direction intersecting the optical axis is greater than a length PIY of the incident surface in the second direction intersecting the optical axis, and an exit surface of the optical path folding element P may be formed so that a length PEX of the exit surface in the first direction intersecting the optical axis is greater than a length PEY of the exit surface in the second direction intersecting the optical axis.

Hereinafter, optical characteristics of the lenses included in the first lens group LG1 and the second lens group LG2 will be described.

The first lens 810 may have a positive refractive power, and may have an object-side surface having a convex shape in a paraxial region thereof, and an image-side surface having a concave shape in a paraxial region thereof. The second lens 820 may have a negative refractive power, and may have an object-side surface having a convex shape in a paraxial region thereof, and an image-side surface having a concave shape in a paraxial region thereof. The third lens 830 may have a positive refractive power, and may have an object-side surface having a convex shape in a paraxial region thereof, and an image-side surface having a concave shape in a paraxial region thereof. The fourth lens 840 may have a positive refractive power, and may have an object-side surface having a convex shape in a paraxial region thereof, and an image-side surface having a concave shape in a paraxial region thereof. The fifth lens 850 may have a negative refractive power, and may have an object-side surface having a concave shape in a paraxial region thereof, and an image-side surface having a concave shape in a paraxial region thereof. The sixth lens 860 may have a positive refractive power, and may have an object-side surface having a convex shape in a paraxial region thereof, and an image-side surface having a convex shape in a paraxial region thereof. The seventh lens 870 may have a negative refractive power, and may have an object-side surface having a concave shape in a paraxial region thereof, and an image-side surface having a concave shape in a paraxial region thereof.

In the optical imaging system 800, some lenses may be configured so that an effective diameter Lx in a first direction intersecting the optical axis, and an effective diameter Ly in a second direction intersecting the optical axis, are different from each other. For example, as illustrated in FIG. 4, the lenses included in the second lens group LG2 in the optical imaging system 800 may be lenses having a D-cut shape in which a portion of a lens is cut away.

The optical imaging system 800 may further include a filter IF and an image plane IP. The image plane IP may be formed on an image sensor IS, and the filter IF may be disposed between the seventh lens 870 and the image plane IP.

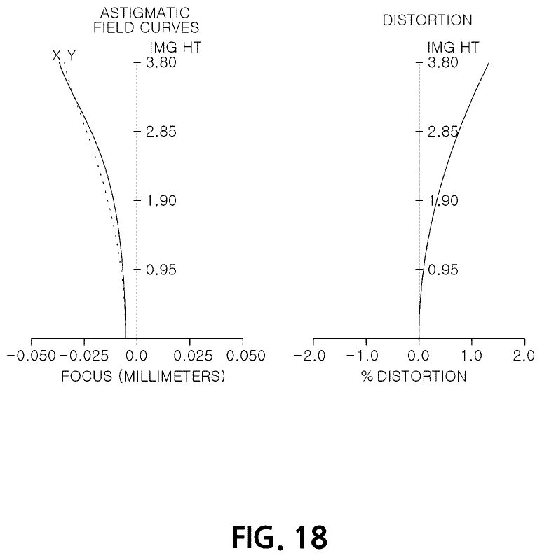

FIG. 18 is a graph illustrating aberration curves of the optical imaging system illustrated in FIG. 17.

Table 15 below lists characteristics of each of the lenses and other elements included in the optical imaging system 800 according to the eighth embodiment.

TABLE 15

| Surface | | Radius of | Thickness/ | Refractive | Abbe | Effective | Effective |
|---|---|---|---|---|---|---|---|
| No. | Element | Curvature | Distance | Index | Number | Radius X | Radius Y |
| S1 | First | 9.250 | 0.884 | 1.535 | 55.7 | 4.279 | 4.279 |
| S2 | Lens | 23.297 | 0.234 | | | 4.100 | 4.100 |
| S3 | Second | 65.725 | 0.400 | 1.614 | 25.9 | 4.028 | 4.028 |
| S4 | Lens | 21.632 | 0.264 | | | 4.021 | 4.021 |
| S5 | Third | 52.667 | 0.417 | 1.544 | 56.0 | 3.881 | 3.881 |
| S6 | Lens | 103.232 | 0.800 | | | 3.874 | 3.874 |
| S7 | Prism | Infinity | 2.800 | 1.717 | 29.5 | 3.817 | 3.817 |
| S8 | | Infinity | 2.800 | 1.717 | 29.5 | 4.000 | 4.383 |
| S9 | | Infinity | 2.500 | | | 4.000 | 2.800 |
| S10 | Fourth | 3.581 | 0.984 | 1.535 | 55.7 | 2.300 | 1.750 |
| S11 | Lens | 131.306 | 0.125 | | | 2.259 | 1.750 |
| | (Aperture) | | | | | | |
| S12 | Fifth | −5692.172 | 0.724 | 1.614 | 25.9 | 2.239 | 1.750 |
| S13 | Lens | 2.876 | 0.677 | | | 1.858 | 1.750 |
| S14 | Sixth | 5.576 | 1.051 | 1.650 | 21.5 | 2.150 | 1.750 |
| S15 | Lens | −8.813 | 0.523 | | | 2.126 | 1.750 |
| S16 | Seventh | −9.747 | 1.200 | 1.639 | 23.5 | 1.992 | 1.750 |
| S17 | Lens | 9.008 | 4.661 | | | 2.118 | 1.750 |
| S18 | Filter | Infinity | 0.210 | 1.517 | 64.2 | | |
| S19 | | Infinity | 3.371 | | | | |
| S20 | Image | Infinity | 0.005 | | | | |
| | Plane | | | | | | |

Table 16 below lists a conic constant k and aspherical surface coefficients A to H and J of each of the lenses included in the optical imaging system 800 according to the eighth embodiment.

TABLE 16

| Surface | | | | | | | |
|---|---|---|---|---|---|---|---|
| No. | S1 | S2 | S3 | S4 | S5 | S6 | S10 |
| k | −0.3294 | 4.277 | −86.9 | −2.983 | 5.903 | 98.66 | 0 |
| A | −4.843E−05 | −7.911E−05 | 0.00002649 | −1.486E−05 | −9.81E−07 | 0.00000148 | 0.0007133 |
| B | 1.743E−06 | −1.006E−06 | 1.224E−07 | 6.547E−06 | 3.13E−08 | −8.829E−08 | −0.0001535 |
| C | 1.218E−07 | 2.724E−09 | 8.264E−08 | 1.88E−07 | 5.661E−10 | −3.192E−09 | −9.539E−06 |
| D | 0 | 0 | 0 | 0 | −4.698E−10 | 6.319E−10 | 1.233E−06 |
| E | 0 | 0 | 0 | 0 | 0 | 0 | 0 |
| F | 0 | 0 | 0 | 0 | 0 | 0 | 0 |
| G | 0 | 0 | 0 | 0 | 0 | 0 | 0 |
| H | 0 | 0 | 0 | 0 | 0 | 0 | 0 |
| J | 0 | 0 | 0 | 0 | 0 | 0 | 0 |

| Surface | | | | | | | |
|---|---|---|---|---|---|---|---|
| No. | S11 | S12 | S13 | S14 | S15 | S16 | S17 |
| k | 0.03707 | 9.90E+01 | −1.387 | 1.181 | −0.05389 | 1.865 | 10.19 |
| A | 1.80E−01 | −4.82E−04 | −8.10E−02 | −3.75E−02 | 1.16E−05 | −9.68E−03 | −9.30E−03 |
| B | −3.11E−01 | 4.81E−06 | 1.45E−01 | 5.95E−02 | −2.48E−06 | −2.83E−04 | 3.39E−04 |
| C | 2.16E−01 | −4.84E−06 | 9.71E−02 | 6.51E−02 | −7.93E−07 | 1.14E−05 | 4.67E−06 |
| D | 7.76E−02 | −4.43E−06 | −5.55E−01 | −1.91E−01 | −1.66E−07 | −1.24E−05 | −4.61E−06 |
| E | −4.06E−01 | 0 | 1.03E+00 | 2.75E−01 | 0 | −6.81E−07 | 0 |
| F | 5.01E−01 | 0 | −1.14E+00 | −2.45E−01 | 0 | 2.75E−07 | 0 |
| G | −3.31E−01 | 0 | 7.59E−01 | 1.34E−01 | 0 | 2.75E−10 | 0 |
| H | 1.14E−01 | 0 | −2.83E−01 | −4.25E−02 | 0 | −5.02E−18 | 0 |
| J | −1.60E−02 | 0 | 4.54E−02 | 6.40E−03 | 0 | −2.22E−19 | 0 |

Table 17 below lists optical and physical properties of the optical imaging system according to the first to eighth embodiments.

TABLE 17

| Property | Embodiment 1 | Embodiment 2 | Embodiment 3 | Embodiment 4 |
|---|---|---|---|---|
| f | 18.092 | 18.089 | 18.220 | 18.262 |
| f1 | 25.986 | 25.501 | 22.387 | 23.131 |
| f2 | −45.449 | −41.847 | −36.302 | −26.943 |
| f3 | 51.787 | 68.912 | 102.198 | 58.657 |
| f4 | 7.004 | 6.687 | 6.912 | 6.910 |
| f5 | −4.858 | −4.917 | −4.811 | −4.720 |
| f6 | 5.909 | 6.307 | 6.226 | 6.003 |
| f7 | −7.042 | −7.134 | −7.882 | −8.010 |
| TTL | 22.448 | 23.463 | 23.815 | 24.480 |
| f-number | 3.006 | 3.102 | 3.173 | 3.313 |
| ImgHT | 3.575 | 3.575 | 3.575 | 3.575 |
| FOV | 22.022 | 22.021 | 21.909 | 21.903 |
| fG1 | 27.756 | 32.862 | 35.692 | 41.045 |
| fG2 | 81.577 | 51.642 | 42.118 | 34.107 |
| Property | Embodiment 5 | Embodiment 6 | Embodiment 7 | Embodiment 8 |
| f | 18.501 | 18.240 | 18.035 | 18.476 |
| f1 | 25.921 | 21.512 | 20.261 | 28.070 |
| f2 | −44.578 | −29.862 | −25.304 | −52.658 |
| f3 | 82.550 | 75.681 | 46.320 | 197.080 |
| f4 | 7.556 | 7.103 | 7.056 | 6.864 |
| f5 | −5.164 | −4.886 | −4.929 | −4.679 |
| f6 | 5.718 | 5.784 | 5.801 | 5.407 |
| f7 | −7.298 | −7.641 | −7.571 | −7.146 |
| TTL | 23.948 | 24.263 | 24.159 | 24.631 |
| f-number | 3.186 | 3.169 | 3.151 | 3.384 |
| ImgHT | 3.575 | 3.575 | 3.575 | 3.575 |
| FOV | 21.681 | 22.058 | 22.300 | 21.645 |
| fG1 | 34.683 | 36.562 | 37.173 | 44.475 |
| fG2 | 43.584 | 37.239 | 35.521 | 31.743 |

Table 18 below lists values of Conditional Expressions 1 to 6 of the optical imaging system according to the first to eighth embodiments.

TABLE 18

| Conditional | | | | |
|---|---|---|---|---|
| Expression | Embodiment 1 | Embodiment 2 | Embodiment 3 | Embodiment 4 |
| \|f/f1\| + \|f/f2\| | 1.094 | 1.142 | 1.316 | 1.467 |
| fG1/f | 1.534 | 1.817 | 1.959 | 2.248 |
| fG1/fG2 | 0.340 | 0.636 | 0.847 | 1.203 |
| h1/h2 | 2.286 | 2.286 | 2.286 | 2.286 |
| SG12/TTL | 0.368 | 0.386 | 0.367 | 0.364 |
| h2/(f − number) | 1.164 | 1.128 | 1.103 | 1.057 |
| Conditional | | | | |
| Expression | Embodiment 5 | Embodiment 6 | Embodiment 7 | Embodiment 8 |
| \|f/f1\| + \|f/f2\| | 1.129 | 1.459 | 1.603 | 1.009 |
| fG1/f | 1.875 | 2.004 | 2.061 | 2.407 |
| fG1/fG2 | 0.796 | 0.982 | 1.046 | 1.401 |
| h1/h2 | 2.286 | 2.286 | 2.286 | 2.445 |
| SG12/TTL | 0.372 | 0.367 | 0.368 | 0.361 |
| h2/(f − number) | 1.098 | 1.105 | 1.111 | 1.034 |

Table 19 below lists values of the conditional expression 0.80<D14/D4I<1.0 and Conditional Expressions 7 to 20 of the optical imaging system according to the first to eighth embodiments.

TABLE 19

| Conditional | | | | |
|---|---|---|---|---|
| Expression | Embodiment 1 | Embodiment 2 | Embodiment 3 | Embodiment 4 |
| D14/D4I | 0.848 | 0.898 | 0.840 | 0.830 |
| f1/f | 1.436 | 1.410 | 1.229 | 1.267 |
| f2/f | −2.512 | −2.313 | −1.992 | −1.475 |
| f3/f | 2.862 | 3.810 | 5.609 | 3.212 |
| f4/f | 0.387 | 0.370 | 0.379 | 0.378 |
| f5/f | −0.269 | −0.272 | −0.264 | −0.258 |
| f6/f | 0.327 | 0.349 | 0.342 | 0.329 |
| f7/f | −0.389 | −0.394 | −0.433 | −0.439 |
| f4/f5 | −1.442 | −1.360 | −1.437 | −1.464 |
| f5/f6 | −0.822 | −0.780 | −0.773 | −0.786 |
| f4/f7 | −0.995 | −0.937 | −0.877 | −0.863 |
| f6/f7 | −0.839 | −0.884 | −0.790 | −0.749 |
| TTL/f | 1.241 | 1.297 | 1.307 | 1.340 |
| BFL/f | 0.399 | 0.365 | 0.385 | 0.401 |
| TTL/ImgHT | 6.279 | 6.563 | 6.662 | 6.848 |
| Conditional | | | | |
| Expression | Embodiment 5 | Embodiment 6 | Embodiment 7 | Embodiment 8 |
| D14/D4I | 0.864 | 0.843 | 0.850 | 0.820 |
| f1/f | 1.401 | 1.179 | 1.123 | 1.519 |
| f2/f | −2.409 | −1.637 | −1.403 | −2.850 |
| f3/f | 4.462 | 4.149 | 2.568 | 10.667 |
| f4/f | 0.408 | 0.389 | 0.391 | 0.372 |
| f5/f | −0.279 | −0.268 | −0.273 | −0.253 |
| f6/f | 0.309 | 0.317 | 0.322 | 0.293 |
| f7/f | −0.394 | −0.419 | −0.420 | −0.387 |
| f4/f5 | −1.463 | −1.454 | −1.432 | −1.467 |
| f5/f6 | −0.903 | −0.845 | −0.850 | −0.865 |
| f4/f7 | −1.035 | −0.930 | −0.932 | −0.961 |
| f6/f7 | −0.784 | −0.757 | −0.766 | −0.757 |
| TTL/f | 1.294 | 1.330 | 1.340 | 1.333 |
| BFL/f | 0.421 | 0.417 | 0.418 | 0.446 |
| TTL/ImgHT | 6.699 | 6.787 | 6.758 | 6.890 |

Table 19 below lists values of Conditional Expressions 21-25 of the optical imaging system according to the first to eighth embodiments.

TABLE 20

| Conditional | | | | |
|---|---|---|---|---|
| Expression | Embodiment 1 | Embodiment 2 | Embodiment 3 | Embodiment 4 |
| R1/R7 | 2.429 | 1.824 | 1.887 | 1.971 |
| R1/R10 | 3.136 | 2.815 | 2.882 | 3.059 |
| R1/R14 | 0.778 | 0.942 | 0.760 | 0.733 |
| R7/R10 | 1.291 | 1.543 | 1.527 | 1.552 |
| R10/R11 | 0.426 | 0.446 | 0.450 | 0.464 |
| Conditional | | | | |
| Expression | Embodiment 5 | Embodiment 6 | Embodiment 7 | Embodiment 8 |
| R1/R7 | 2.556 | 2.479 | 2.436 | 2.583 |
| R1/R10 | 3.155 | 3.127 | 3.092 | 3.216 |
| R1/R14 | 0.847 | 0.737 | 0.757 | 1.027 |
| R7/R10 | 1.234 | 1.261 | 1.269 | 1.245 |
| R10/R11 | 0.430 | 0.396 | 0.401 | 0.516 |

The embodiments described above provide an optical imaging system having a long focal length that can mounted in a small electronic device.

While this disclosure includes specific embodiments, it will be apparent after an understanding of the disclosure of this application that various changes in form and detail may be made in these embodiments without departing from the spirit and scope of the claims and their equivalents. Descriptions of features or aspects in each embodiment are to be considered as being applicable to similar features or aspects in other embodiments. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens group comprising a first lens, a second lens, and a third lens;
a second lens group comprising a fourth lens, a fifth lens, a sixth lens, and a seventh lens; and
an optical path folding element disposed between the first lens group and the second lens group,
wherein the first to seventh lenses are sequentially disposed in ascending numerical order along an optical axis of the optical imaging system from an object side of the optical imaging system toward an image plane of the optical imaging system, and
the first lens has a positive refractive power.

2. The optical imaging system of claim 1, wherein an object-side surface of the first lens has a convex shape in a paraxial region thereof.

3. The optical imaging system of claim 1, wherein an image-side surface of the second lens has a concave shape in a paraxial region thereof.

4. The optical imaging system of claim 1, wherein an object-side surface of the third lens has a convex shape in a paraxial region thereof.

5. The optical imaging system of claim 1, wherein an object-side surface of the fourth lens has a convex shape in a paraxial region thereof.

6. The optical imaging system of claim 1, wherein an image-side surface of the fifth lens has a concave shape in a paraxial region thereof.

7. The optical imaging system of claim 1, wherein an object-side surface of the sixth lens has a convex shape in a paraxial region thereof.

8. The optical imaging system of claim 1, wherein an object-side surface of the seventh lens has a concave shape in a paraxial region thereof.

9. The optical imaging system of claim 1, wherein the following conditional expression is satisfied:
$$0.3 \leq fG 1 / fG 2 \leq 2.0$$
where fG1 is a focal length of the first lens group, and fG2 is a focal length of the second lens group.

10. The optical imaging system of claim 1, wherein the fourth lens is a D-cut lens having an object-side surface having a maximum effective diameter and a minimum effective diameter less than the maximum effective diameter, and
the following conditional expression is satisfied:
$$1. 0 \leq h 1 / h 2 \leq 3.0$$
where h1 is an effective diameter of an object-side surface of the first lens, and h2 is the minimum effective diameter of the object-side surface of the fourth lens.

11. The optical imaging system of claim 1, wherein the following conditional expression is satisfied:
$$0.3 \leq SG 12 / TTL \leq 1.$$
where SG12 is a distance along the optical axis from an image-side surface of the third lens to an object-side surface of the fourth lens, and TTL is a distance along the optical axis from an object-side surface of the first lens to the image plane.

12. An optical imaging system comprising:
a first lens, a second lens, a third lens, a fourth lens, a fifth lens, a sixth lens, and a seventh lens sequentially disposed in ascending numerical order along an optical axis of the optical imaging system from an object side of the optical imaging system toward an image plane of the optical imaging system,
wherein an image-side surface of the fifth lens has a concave shape in a paraxial region thereof, and
the following conditional expression is satisfied:
$$0.8 < D 14 / D 4 l < 1.$$
where D14 is a distance along the optical axis from an object-side surface of the first lens to an object-side surface of the fourth lens, and D4I is a distance along the optical axis from the object-side surface of the fourth lens to the image plane.

13. The optical imaging system of claim 12, wherein the object-side surface of the first lens has a convex shape in a paraxial region thereof.

14. The optical imaging system of claim 12, wherein an image-side surface of the second lens has a concave shape in a paraxial region thereof.

15. The optical imaging system of claim 12, wherein an object-side surface of the third lens has a convex shape in a paraxial region thereof.

16. The optical imaging system of claim 12, wherein the object-side surface of the fourth lens has a convex shape in a paraxial region thereof.

17. The optical imaging system of claim 12, wherein an object-side surface of the sixth lens has a convex shape in a paraxial region thereof.

18. The optical imaging system of claim 12, wherein an object-side surface of the seventh lens has a concave shape in a paraxial region thereof.

19. The optical imaging system of claim 12, wherein the fourth lens is a D-cut lens,
the object-side surface of the fourth lens has a maximum effective diameter, and a minimum effective diameter less than the maximum effective diameter, and
the following conditional expression is satisfied:
$$1. 0 \leq h 1 / h 2 \leq 3.0$$
where h1 is an effective diameter of the object-side surface of the first lens, and h2 is the minimum effective diameter of the object-side surface of the fourth lens.

20. The optical imaging system of claim 12, wherein the following conditional expression is satisfied:
$$6. < TTL / ImgHT < 8.$$
where TTL is a distance along the optical axis from an object-side surface of the first lens to the image plane, and ImgHT is one half of a diagonal length of the image plane.
